(19) United States
(12) Patent Application Publication
(10) Pub. No.: US 2007/0139756 A1
(43) Pub. Date: Jun. 21, 2007

(54) Stable Electro-Chromic Device

(76) Inventors: Anoop Agrawal, Tucson, AZ (US); John P. Cronin, Tucson, AZ (US); Juan Carlos Tonazzi Lopez, Tucson, AZ (US); Lori L. Adams, Tucson, AZ (US)

Correspondence Address: WILLIAM J. KOLEGRAFF, 3119 TURNBERRY WAY, JAMUL, CA, 91935, US

(21) Appl. No.: 11/461,113

(22) Filed: Jul. 31, 2006

Related U.S. Application Data
(60) Provisional application No. 60/703,673, filed on Jul. 29, 2005.
(60) Provisional application No. 60/720,986, filed on Sep. 27, 2005.

(51) Int. Cl. G02F 1/15

(52) U.S. Cl. 359/265

(57) ABSTRACT

A stable electrochromic stack is provided that is able to persistently hold a desired optical state. The stable electrochromic stack has at least two states. One state may be, for example, a bleached state in which light may readily pass, and the other state may be a colored state that distorts or interferes with the passage of light. Advantageously, the persistent electrochromic stack holds one or both of the optical states without the application of external power. The persistent time period may extend for days, weeks, or years depending on particular constructions, and on application requirements.

### RELATED APPLICATIONS

This application claims priority to U.S. patent application Ser. No. 60/703,673, filed Jul. 29, 2005, and entitled “Devices for Optical Media”, and to U.S. patent application Ser. No. 60/720,986, filed Sep. 27, 2005, and entitled “Devices and Processes for Optical Media”, both of which are incorporated by reference as if set forth in their entirety. This application is also related to U.S. patent application Ser. No. 11/460,827, filed Jul. 28, 2006, and entitled, “Persistent Electro-Optic Devices and Processes for Optical Media”, which is also incorporated by reference.

### FIELD

The present invention relates to materials and compositions for forming stable and persistent electrochromic film stacks, and to associated processes for using and making themn

### BACKGROUND

Electrochromic (EC) devices known in the art have a substantial potential between the two electrodes in at least one of the optical states. An electrochromic device is typically controlled or driven by an external circuit that applies an electrical charge when a state change is desired. Depending on circuit design, when the circuit is not actively driving the electrochromic material, the external circuit may present an impedance between the two electrodes from a short to about 20 Mohms. When sufficient potential exists between electrodes, the driving circuit will allow current to drain between electrodes, thereby allowing the electrochromic material to transition from its desired state to an undesirable rest state. Also if diodes (including surface diodes) are used in external circuits then these diodes may be turned on by residual potential in an EC device. If these diodes are turned on, then current will flow, allowing the EC material to transition from its desired state. A typical voltage range to turn on the diodes are between 0.2 to 1V. Since most know EC devices produce more potential than 0.2 volts, these known devices return to an undesired rest state, unless external power is periodically applied. To avoid activating the diodes, an EC device should have a residual voltage in any of its optical states (usable optical range for a particular application) to be less than 0.2V and preferably close to 0 volts.

### SUMMARY

Briefly, the present invention provides a stable electrochromic stack that is able to persistently hold a desired optical state. The stable electrochromic stack has at least two states. One state may be, for example, a bleached state in which light may readily pass, and the other state may be a colored state that distorts or interferes with the passage of light. Advantageously, the persistent electrochromic stack holds one or both of the optical states without the application of external power. The persistent time period may extend for days, weeks, or years depending on particular constructions, and on application requirements.

In one example, the electrochromic stack is constructed by positioning an electrochromic layer adjacent to an electrolyte layer. Electrodes typically attach to the layers for connection to a powering circuit. When in a first optical state, for example a dark state, the electrolyte is in a highly stable state. Accordingly, there is almost no potential between the electrochromic layer and the electrolyte layer, so the electrochromic stack maintains the first optical state persistently. Upon the application of a voltage, the electrochromic layer (any possibly the electrolyte layer) transition to a second optical state, for example, a bleached state. The electrolyte layer also transitions from its first highly stable state to a second highly stable state. After the voltage is removed, there is almost no potential between the electrochromic layer and the electrolyte layer, because the electrolyte layer is in a highly stable state. Accordingly, the electrochromic stack maintains its second optical state persistently because the electrolyte layer is in a highly stable state

In one example, the stable electrochromic stack is used with an associated optical media, and more particularly, as part of an optical shutter. The optical media has an integrated circuit, which is used to cause the electrochromic stack to transition from a first state to the second state. In one example, an integrated circuit acts as the powering circuit for the electrochromic stack, as well as providing logic and processing functions. The integrated circuit also couples to an RF antenna, enabling the integrated circuit to communicate with an associated RF scanning device. It will be appreciated that many other fields and applications may benefit from a persistent electrochromic stack.

Advantageously, the persistent electrochromic device enables an optical shutter to be positioned on or in an optical disc, and for the shutter to maintain its bleached or colored state. In this way, a darkened shutter may disable access to the disc when the disc is manufactured, and then the disc moved through a distribution chain with confidence that the disc will remain unusable until an authorization event occurs. Upon the authorization event, for example, a consumer purchase, the optical shutter is transitioned to its clear state, and the clear state will be maintained, allowing the consumer to use the disc for years.

### BRIEF DESCRIPTION OF DRAWINGS

FIG. 1 is a diagram of a stable electrochromic device in accordance with the present invention.

FIG. 2A is a diagram of an stable organic electrochromic device in accordance with the present invention.

FIG. 2B is a diagram of an stable inorganic electrochromic device in accordance with the present invention.

FIGS. 3A and 3B are diagrams of a stable electrochromic devices in accordance with the present invention.

FIG. 4 is a diagram of a stable electrochromic device transitioning optical states in accordance with the present invention.

FIG. 5 is a diagram of a stable electrochromic device reversibly transitioning optical states in accordance with the present invention.

FIG. 6 is a diagram of a stable electrochromic device in accordance with the present invention

FIG. 7 is a diagram of a stable electrochromic device in accordance with the present invention.

FIG. 8 is a flow diagram of operating a stable electrochromic device in accordance with the present invention.

FIG. 9 is a flow diagram of operating a stable organic electrochromic device in accordance with the present invention.

FIG. 10 is a flow diagram of operating a stable inorganic electrochromic device in accordance with the present invention.

FIG. 11A is a diagram of a stable electrochromic device with enhanced adhesion in accordance with the present invention.

FIG. 11B is a diagram of a stable electrochromic device with modified optical qualities in accordance with the present invention.

FIG. 12 is a block diagram of an EC device stack in accordance with the present invention.

FIG. 13 is a block diagram of an EC device stack in accordance with the present invention.

FIG. 14 is a block diagram of an EC device stack in accordance with the present invention.

FIG. 15 is a block diagram of an EC device stack in accordance with the present invention.

FIG. 16 is a block diagram of an EC device stack in accordance with the present invention.

FIG. 17 is a graph showing % transmission versus wavelength for an EC material in accordance with the present invention.

FIG. 18 is a graph showing % transmission versus wavelength for ITO and IZO in accordance with the present invention.

FIG. 19 is a block diagram of an EC device stack in accordance with the present invention.

FIG. 20 is a diagram of an optical disc with an EC device in accordance with the present invention.

FIG. 21 is a graph showing transition timing for an EC device in accordance with the present invention.

FIG. 22 is a graph showing transition timing for an EC device in accordance with the present invention

FIG. 23 is a graph showing transition timing for an EC device in accordance with the present invention.

FIG. 24 is a photograph of an EC Device in accordance with the present invention.

FIG. 25 is a graph showing error rate for a disc using an EC device in accordance with the present invention.

### DETAILED DESCRIPTION

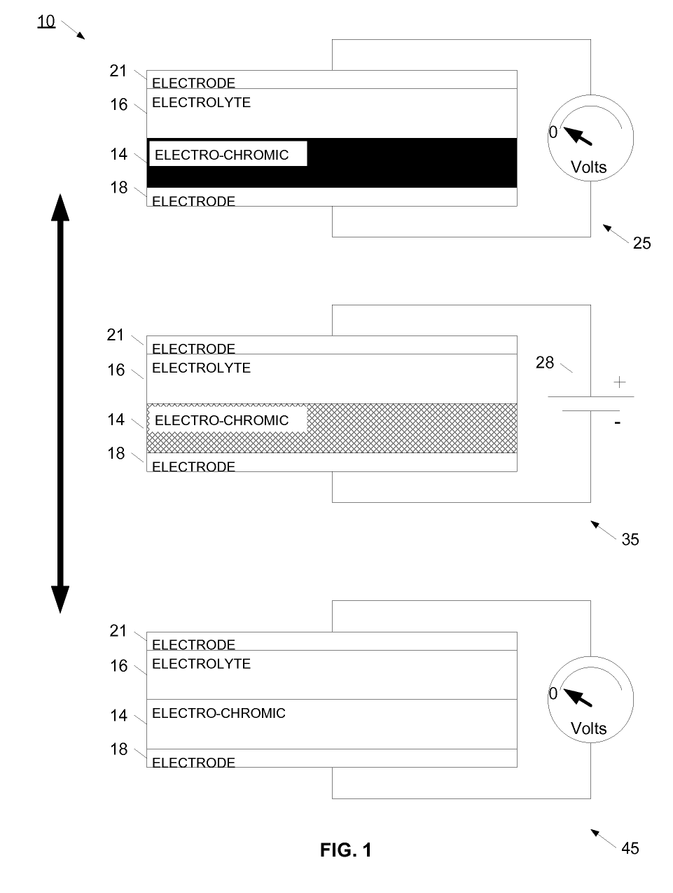

Referring now to FIG. 1, a stable electrochromic stack 10 is illustrated. Stable electrochromic stack 10 generally comprises an electrochromic material 14 placed adjacent an electrolyte material 16. A pair of electrodes 18 and 21 connect to the electrolyte and electrochromic material respectively. The electrochromic stack 10 typically has two optical states, although more may be provided for specific applications. In a first optical state, light is blocked from passing through the stack 10, or is substantially distorted. In another state, the light is allowed to pass through the stack without meaningful distortion, so the stack is described as being substantially transparent. The change in optical state may be due to a change in optical state of the electrochromic material 14, or may be due to a change in both the electrochromic material 14 and the electrolyte 16. In one example the electrolyte material 16 is always in a substantially transparent state, and an application of voltage causes the electrochromic material 14 to transition between a first state and the second state. In another example, the electrolyte material and the electrochromic material are both substantially transparent in the first state, and both the electrolyte 16 and electrochromic 14 transition to a more opaque state upon the application of the voltage. It will also be understood that the stable electrochromic stack 10 may have additional layers. The general construction of electrochromic devices is well known so will not be described in detail. However, stable electrochromic device 10 advantageously provides for persistent stability when the electrochromic device is in a desired optical state.

For example, stable electrochromic device 10 may be in an initial opaque state as shown in arrangement 25. In arrangement 25, the electrochromic material 14 is opaque and thereby interfering with the passage of light. The interference may include a blocking of all or a substantial portion of the light, a change in refraction, a blurring effect, or another optical effect distorting the passage of light. It will also be appreciated that the electrochromic material may substitute another electro-optic material for affecting other wavelengths, or having other desirable optical effects. Advantageously, when the electrochromic material 14 is in its colored state, the electrolyte 16 is in a stable condition, such as a stable oxidation state. Accordingly, there is almost no potential generated between electrodes 18 and 21. With proper selection of materials, the potential between electrodes and across the electrochromic stack is small enough that even shorting between electrodes will not cause the electrochromic material 14 to immediately transition to its rest state. For example, with proper selection of electrolyte and electrochromic materials, and selection of proper additives, the electrochromic stack will persistently maintain its colored state for several days or weeks, even when electrodes 18 and 21 are shorted. This means that in normal use, where the electrochromic device is typically not shorted, and instead may be constructed to have a relatively large impedance, the electrochromic stack may persistently remain in the darkened state for months, years, or even decades. For purposes of this discussion, a persistent state means that the electrochromic material maintains its desired optical state for a time sufficient for the application. For example, some applications may require that an electrochromic device maintain a darkened state for several months, while other applications may require a few years. It will be appreciated that the teachings of this discussion may be used to select materials, select additives, and adjust processes for meeting a wide range of persistent durations.

When a voltage 28 is applied to the electrodes of the electrochromic stack 10, ions pass between the electrolyte layer 16 and the electrochromic layer 14. As shown in arrangement 35, the electrochromic layer 14 will then transition from its opaque state towards a substantially transparent state. This transition may take anywhere from less than a second to a few seconds. The speed of transition is typically related to the amount of available current. For example, faster transitions may be made with the application of larger current sources. It will also be understood that the amount of electrochromic material to transition also affects speed of transition. For example, a large picture window covered with an electrochromic device would take substantially more current and time to transition than a small optical shutter placed on an optical desk.

After the transition is complete as shown in arrangement 45, the electrochromic stack once again returns to a stable state. Accordingly, the electrochromic material 14 persistently stays in its substantially transparent state. In a substantially transparent state, an electrochromic material provides little distortion or interference to passing light. With the ion movement caused by the application of voltage during the transition state 35, the electrolyte layer 16 has reacted to another highly stable state. For example, in arrangement 45, the electrolyte layer 16 may have moved to a different but very stable oxidation state. Since the electrolyte material 16 in arrangement 14 is in a highly stable condition, the electrochromic device 10 has almost no tendency to transition to a rest state. This is evidenced by the near-0V potential between electrodes 18 and 21. Accordingly, the substantially transparent state of the electrochromic material 14 may be maintained persistently. As generally described above, this means that the electrochromic material 14 maintains its desirable substantially transparent state for as long as required by the specific application. For example, some applications may require that the electrochromic material remain clear for days or weeks, while other applications may require that the electrochromic material persistently stay bleached for months, years or even decades. Again, it will be appreciated that the teachings of this discussion may be used by one skilled in the art to select appropriate electrolyte and electrochromic materials, and appropriately provide additives or dopants for reaching the required persistent durations.

Advantageously, a stable electrochromic device maintains its desired optical state for a persistent duration. More particularly, this means that an electrical device is enabled to maintain its desired state without continuous, continual, or periodic applications of external voltage. In contrast, known electrical devices require at least some application of external voltage to maintain either a bleached or colored state. Since the known electrical devices require periodic application of external power, their uses have been limited, or have required cumbersome connections to electrical power sources. With a persistent electrochromic stack, many applications are enabled or simplified. For example, electrochromic devices may now be used as optical shutters for optical disks. Such an application is more fully described in co-pending U.S. patent application Ser. No. 11/460,827, filed Jul. 28, 2006, and entitled “Persistent Electro-Optic Devices and Processes for Optical Media”, which is incorporated herein by reference in its entirety. In another example, larger transparent or reflective surfaces may be set to a darkened or bleached state, and that optical state maintained without application of external electricity. For large areas, this saves considerable power, and enables more efficient electronic control of light. It will be understood that this discussion describes an electrochromic device having a fully colored state and a fully bleached state, however more states may be provided. In this way, an intermediate persistent state could be provided which passes partial or blurred light. It will also be understood that electrochromic devices discussed herein have a wide range of applications in military, industrial, automotive, and entertainment fields.

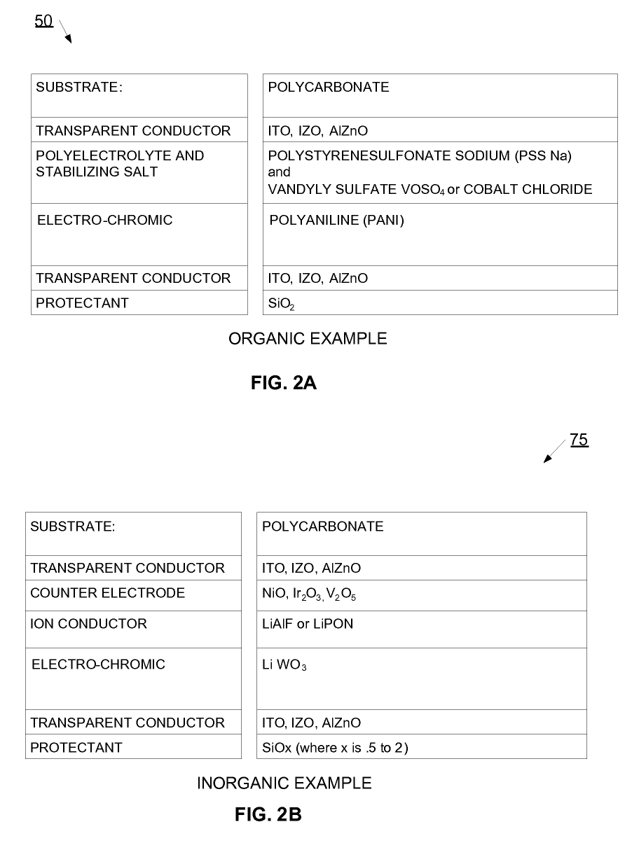

Referring now to FIG. 2A, particular examples of stable electrochromic stacks are described. FIG. 2A shows a stable electrochromic stack 50 having an organic electrochromic layer. The organic electrochromic layer is positioned adjacent an electrolyte layer having a polyelectrolyte and stabilizing salt. When the electrochromic layer is in its first optical state, the polyelectrolyte is in a highly stable first state. Upon the application of a voltage to the stack 50, the electrochromic layer and polyelectrolyte/salt layer past ions or electrons, and initiate a reaction that causes the electrolyte to transition to a second highly stable state. In one sample, this second highly stable state is another stable oxidation state. In example 50, the electrochromic material is selected to be polyaniline (PANI), and the polyelectrolyte is a Poly styrene sulfonate-Na salt (PSS—Na) with a VOSO₄ salt. It will be appreciated that other organic substances may be substituted. A set of conductors is provided, with each conductor typically being a transparent conductor. In one example, the transparent conductor is an ITO (indium-tin oxide), although other transparent conductors may be used such as IZO (indium-zinc oxide). It will be understood that the selection of transparent conductors may be made responsive to the frequencies of light to be passed, or other considerations. For example, low temperature deposited (e.g., less than 100 C substrate temperature) IZO has been particularly advantageous for passing light in the 405 nm wavelength range. In a similar manner, low temperature deposited ITO has been found to be effective at passing in the 650 nm wavelength range. The entire electrochromic stack may be placed on a substrate, such as a plastic, polycarbonate, or glass substrate. Since some electrochromic materials are sensitive to oxidation, it may also be desirable to apply a protective layer to the electrochromic stack 50 from oxygen and moisture. For example, SIOₓ(x=0.5−2) or other protective coating may be used, according to application needs. Again, the particular protectant may be selected based upon its transmissive qualities. The protectant may also be used to protect the transparent conductor and electrochromic material from physical damage, such as scratches.

Referring now to FIG. 2B, and inorganic electrochromic stack 75 is illustrated. As with stack 50 just described, the stack 75 has a plastic, glass, or polycarbonate substrate, and has a protectant positioned on top of the transparent conductor and electrochromic layers. The transparent conductors would be selected according to the guidance provided for stack 50. The inorganic stack 75 has an electrochromic layer, for example such as LiWO₃. An ion conductor layer is positioned adjacent to the electrochromic layer. In one example, the ion conductor is LiAlF. It will be appreciated that other ion conductors may be used in a counter electrode. A counter electrode is also provided adjacent the ion conductor. The counter electrode may be for example, NiO or Ir₂O₃. In the inorganic example, the counter electrode is in a first stable oxidation state when the electrochromic layer is in its first optical state. In general such stacks are used for reversible devices, but the materials may be tailored such that when the ions are introduced into the counterelectrode, or extracted from it, the change in it is not reversible and the ions are unable to escape or enter respectively. One may also change the electronic conductivity of a layer by this ion insertion or extraction to an extent that it becomes an insulator thus blocking any further changes. Accordingly, the electrochromic layer may persistently maintain its desired optical state. Upon the application of voltage, ions pass through the ion conductor and cause the counter electrode to react and transition to a second highly stable oxidation state. The materials are selected so that when the counter electrode is in its stable second state, the electrochromic material has sufficiently transitioned to its second optical state. Since the counter electrode is now in a highly stable second state, the electrochromic material is able to maintain its second optical state persistently.

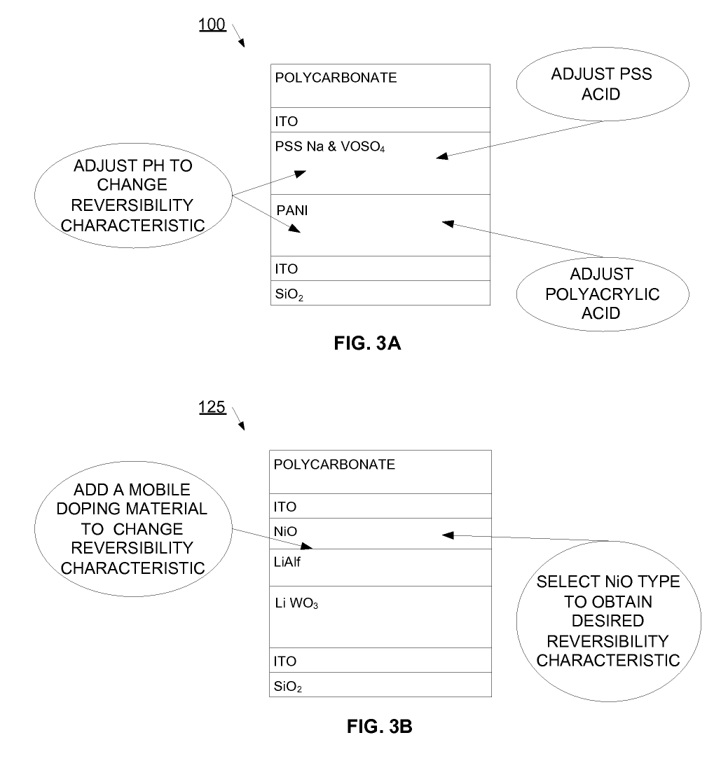

Referring now to FIG. 3A, an electrochromic stack 100 is illustrated. Electrochromic stack 100 is similar to electrochromic stack 50 described earlier, so will not be described in detail. It has been found that by adjusting the pH relationship between the electrochromic layer and the electrolyte layer, the characteristics of the organic stack 100 may be adjusted. For example it can effect reversibility, kinetics and the extent of optical change.

Referring now to FIG. 3B, and organic stack 125 similar to organic stack 75 is illustrated. Inorganic stack 125 has mobile doping material applied to the counter electrode to change the reversibility characteristics of the device 125. More particularly, the counter electrode may be doped, or in some cases the material type for the counter electrode may be selected for desirable reversibility effects. For example, if the counter electrode is NiO, then the particular type of nickel oxide selected will affect reversibility characteristics. For example it has been seen that for devices using lithium ion NiO is less reversible as compared to lithium-nickel oxide which may be formed by depositing nickel oxide followed by a layer of lithium that penetrates the underlying layer resulting in lithium-nickel oxide. In some devices, prolonged application of power cements a more permanent bond between the host matrix and the mobile ions making the change irreversible.

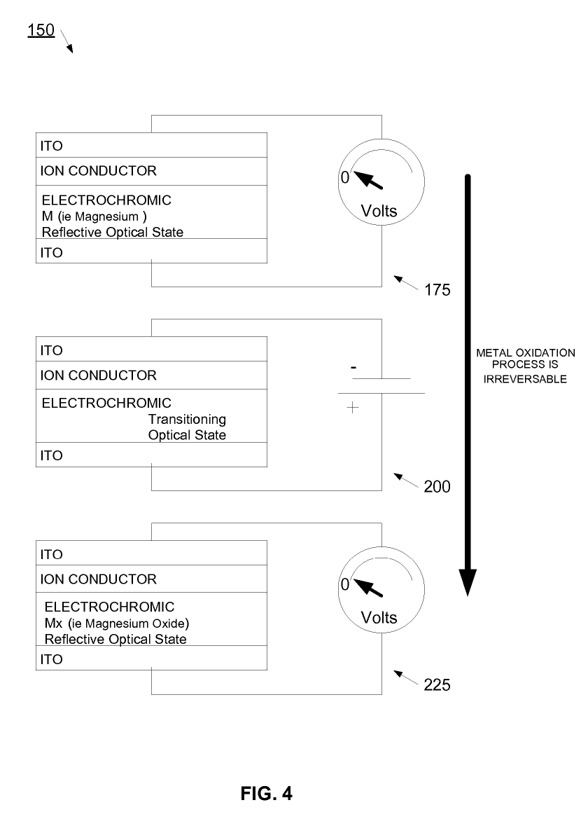

Referring now to FIG. 4, another electrochromic stack device 150 is illustrated. Electrochromic device 150 is a device constructed to bleach with oxidation. In this way the electrochromic coating is a metallic layer which is blocking to the incoming light. Upon the application of voltage, the electrolyte layer oxidizes the electrochromic layer while it itself reduces. Importantly, the electrochromic layer is a highly stable oxidation state. As illustrated in arrangement 175, the electrochromic layer, which is shown as magnesium, is in its colored state. Being a metal, the colored state may be a highly reflective optical state. Accordingly, light does not readily pass through the electrochromic device, so the device acts as an effective disruption or interference to a light beam. M can be equal to any metal which can be oxidized to a state which is non-blocking to light. Examples of such metals are, magnesium, nickel, manganese, copper, indium, cobalt, tungsten, molybdenum, aluminum, tin, zinc their alloys, or even where more than 1 layer (each layer being a different metal composition) is combined to form a composite EC layer. When different layers are used, these layers may even have same metallic compositions but different compounds of the same material, e.g., a metal layer with a 1-10 nm thick metal oxide layer. The ion conductor layer, which may be for example a non aqueous electrolyte with an oxidant (Y) such as benzoquinone or metal nitrates such as zinc nitrate hydrate or other oxidants, these materials are capable of being reduced. Accordingly, upon the application of voltage as shown in arrangement 200, ions pass between the ion conductor and the metal which acts to reduce the ion conductor layer and oxidized the metal. In this way, the metal participates in an irreversible chemical reaction creating a metal compound MX where X can be for example oxygen, chlorine, fluorine, sulfates, nitrates or the like. MX is substantially transparent, enabling the device as shown in arrangement 225 to be substantially transparent. In this state, the electrochromic device does not substantially interfere or distort passing light. Advantageously, electrochromic device is stable both the when the metal is in its metallic state 175 or in its oxidized state 225. More particularly, the ion conductor layer is in a highly stable oxidation state when the electrochromic layer is both in its colored state and in its bleached state.

The metal layer may be made very thin, for example 20-50 nm. By reducing the thickness of the metal, reduced optical path effects are generated. This enables better transmission when the metal is in its oxidized state. These metal coatings may also be porous so that the electrolyte intercalates through these pores reducing kinetic considerations. It will be understood that other metal materials may also be used. The electrochromic device 150 is generally a one-way or irreversible process. The electrochromic device 150 may be initially provided in its bleached state as shown in arrangement 175, and then be “one-way” transitioned to its colored state. Alternatively, the electrochromic device may be initially provided in its colored state, and then be “one-way” transitioned to its bleached state. Voltage is applied that transitions the device to its fully bleached state as shown in arrangement 225, and the electrochromic layer permanently changes or reacts to MX. An application oftypical transition voltages would not be effective to return the electrochromic layer to a colored state. However, it will be appreciated that some high voltages may be able to at least partially recolor the electrochromic layer. However under normal operating conditions the device 150 would be considered a one-way, irreversible process.

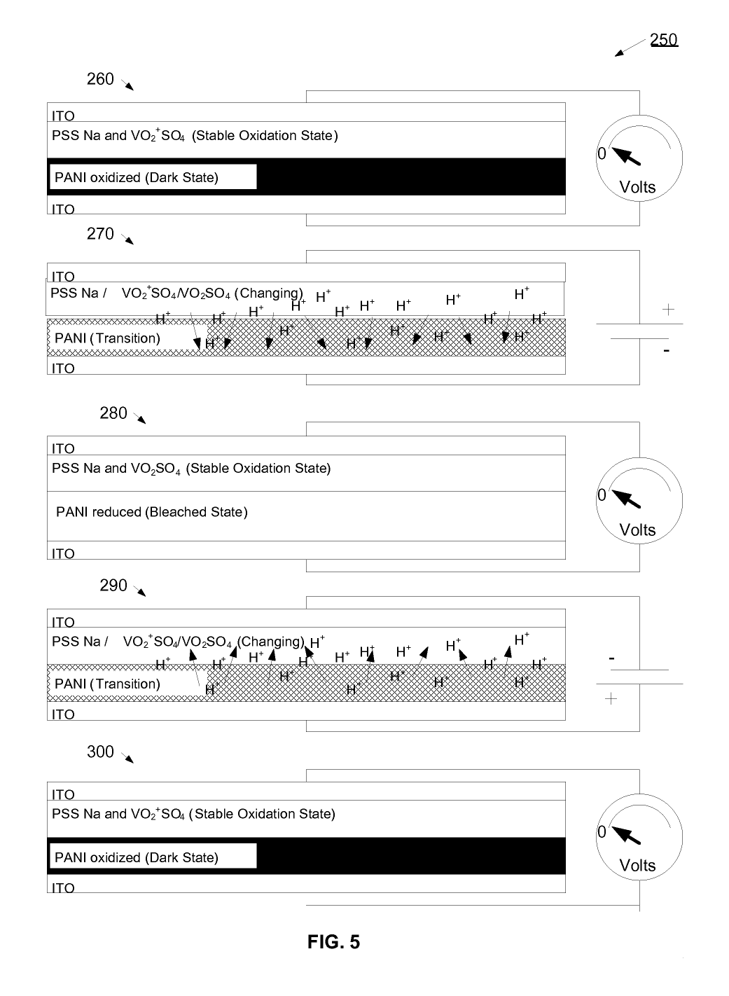

Referring now to FIG. 5, an organic electrochromic device 250 having at least limited reversibility is illustrated. It will be understood that reversibility characteristics may be adjusted according to selected compositions and additives. Device 250 has an electrochromic layer in the form of PANI, which in its oxidized state is dark as shown in arrangement 260. An electrolyte layer containing PSS—Na and VOSO₄ is arranged adjacent to the electrolyte layer. Transparent conductors are attached to the electrolyte layer and the electrochromic layer. Since the electrolyte layer is in a highly stable oxidation state, almost no voltage is generated across the electrochromic device. Accordingly, the electrochromic layer persistently holds its colored state. Upon the application of a voltage as shown in arrangement 270, ions pass from the electrolyte layer to the electrochromic layer, which begins to reduce the PANI. After reduction is complete, the PANI is reduced, and therefore transparent as shown in block 280. The movement of ions from the electrolyte layer has resulted in the electrolyte layer reacting to a second highly stable oxidation state as shown in block 280. Again, since the electrolyte layer is a highly stable oxidation state, almost no voltage exists across the electrochromic device. When an oxidizing voltage is applied to the electrochromic device as shown in block 290, a reverse process occurs were ions move from the electrochromic layer back to the electrolyte layer as shown in arrangement 290. After oxidation is complete, the electrolyte is once again in a highly stable oxidation state, which is the same state that is shown in arrangement to 60, thereby allowing the electrochromic material to maintain its colored state persistently. As generally described herein, the pH of the electrolyte and electrochromic layers may be adjusted to change the reversibility characteristics of the device. For example, the pH may be adjusted so that long-term reversibility is maintained. In another example, the pH may be adjusted to make the device substantially irreversible, that is, the device may be fully or somewhat reversible but only under long applications of voltage, or applications of non-typically high voltages. In another example, limited reversibility may be enabled by adjusting the pH. In this case, the electrochromic device may be reversible for a limited number of times, and then become somewhat or fully irreversible overtime.

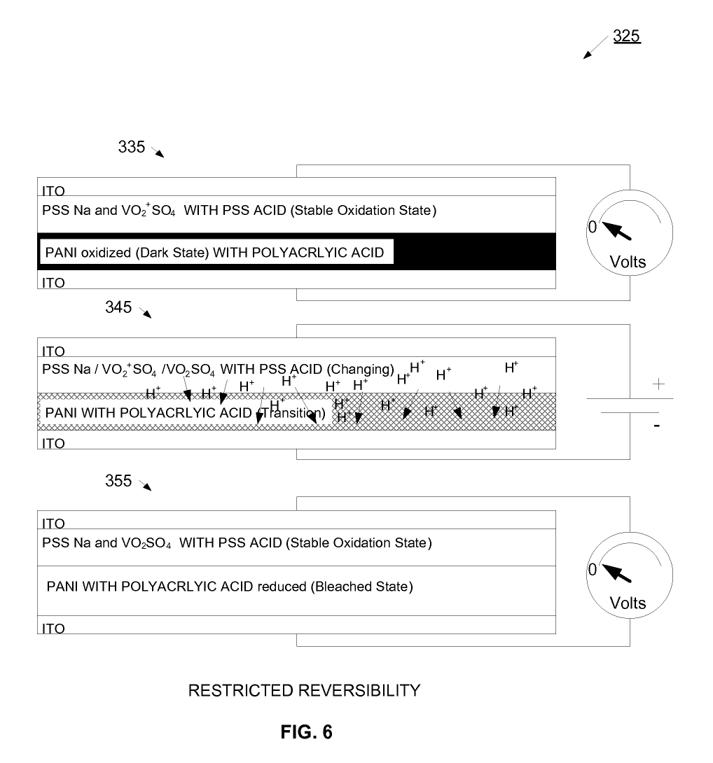

Referring now to FIG. 6, an organic electrochromic device 325 is illustrated. As generally described with reference to FIG. 5, the organic device 325 has had its pH adjusted to limit or restrict reversibility and other characteristics. Depending upon the particular pH selected for the electrolyte and electrochromic layers, the reversibility characteristics fro the device may be adjusted. For example, the pH levels may be set to allow for limited reversibility, or maybe set to make the device substantially irreversible. To construct device 325 with restrict reversibility, PSS acid has been added to the PSS—Na/ VOSO₄ electrolyte layer, and polyacrylic acid has been added to the PAN11ayer. The electrolyte layer is in a highly stable oxidation state, so the oxidized PANI electrochromic layer is substantially opaque as shown in arrangement 335. Upon the application of a reducing voltage as shown in arrangement 345, the electrolyte layer passes hydrogen ions to the electrochromic layer, thereby reducing the PANI, and transitioning the electrolyte layer from its first stable state to a second stable state. After reduction is complete, as shown in block 355, the electrolyte layer once again is in a highly stable oxidation state, and the PANI electrochromic +2 layer is thereby able to maintain its bleached state persistently, as almost no voltage is generated across the electrochromic device. It will also be understood that the adding an acid to the electrochromic and electrolyte layers may have an effect on the stability of the electrolyte layer, thereby affecting the level of voltage generated at the stable states. Generally, the change in pH in one or both the layers affects the reducing and oxidizing potential between the electrochromic and electrolyte layers.

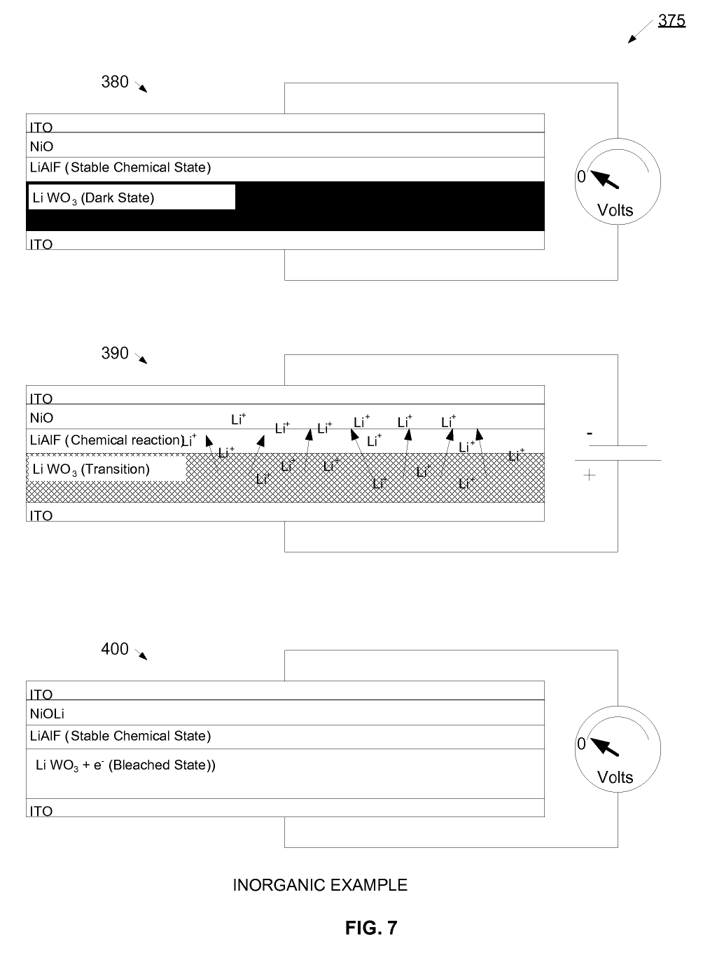

Referring now to FIG. 7, and inorganic electrochromic device 375 is illustrated. Organic device 375 uses LiWO₃ as its electrochromic layer, and LiAlF material as its ion conductor, and NiO as its counter electrode. This electrode may be hydrated or have a structure so that it can react with lithium irreversibly. A pair of transparent conductors (ITO) is attached as previously described. Since the NiO and the LiAlF are in highly stable chemical states, almost no potential is generated across the device, so the electrochromic material is able to maintain its dark state persistently. When an oxidizing voltage is applied as shown in block 395, ions transition from the electrochromic layer, through the ion conductor layer, and towards the boundary of the counter electrode. The counter electrode accepts the lithium ions, thereby chemically changing some of the NiO to NiOLi as shown in arrangement 400. Since NiOLi is a highly stable oxidation state, almost no voltage is generated across the electrochromic device, enabling the electrochromic layer to maintain its bleached state persistently. As illustrated, the electrochromic device 375 would have limited reversibility, and in many respects may be considered irreversible.

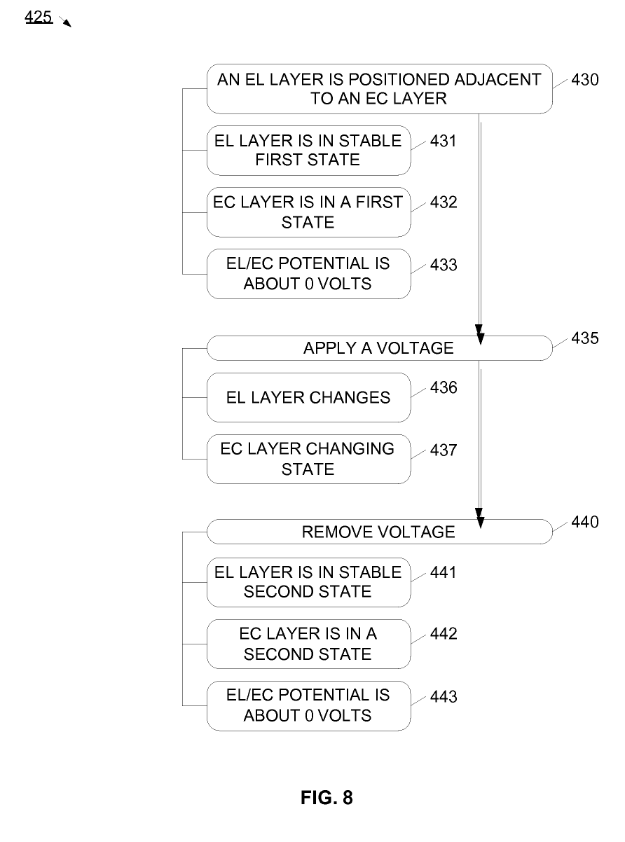

Referring now to FIG. 8, a process 425 using an electrochromic device is illustrated. The electrochromic device described and used in process 425 is a highly stable electrochromic device. This means, the electrochromic device is able to maintain an optical state persistently without the application of external voltages. When the electrochromic device is manufactured, and electrolyte layer is positioned adjacent to the electrochromic layer as shown in block 430. It will be understood that the electrochromic layer may be, for example, an organic material, an inorganic material, or a metal material. The electrolyte layer is in a first stable state as shown in block 431. This first stable state may be a highly stable chemical state, oxidation state, or polymerization state. The electrochromic layer is in a first optical state as shown in block 432. This first optical state may be either a substantially transparent/bleached state, or a colored/dark state. It will also be understood that the electrolyte layer may also have optical states, such that when the electrochromic layer is dark the electrolyte layer also darkens, and when electrochromic layer bleaches, the electrolyte layer also becomes more transparent. In this case, the electrolyte layer and electrochromic layer cooperate to intensify the effect of the optical states. Since the electrolyte layer is in a highly stable state, there is almost no potential generated across electrical device as shown in block 433. Accordingly, the device is able to persistently hold its first optical state.

When it is desired to change the optical state of the electrochromic device, a voltage is applied as shown in block 435. Depending upon the type of reaction intended to occur; the voltage may be applied as a reducing voltage or an oxidizing voltage. The application of voltage causing an ion or current flow that causes the electrochromic layer to transition from its first optical state to a second optical state as shown in block 437. More particularly, electrochromic layer transitions from its bleached state towards a darkening state, or from its colored state towards a more transparent state. At the same time, the electrolyte layer also has a chemical, polymerization, or oxidation/reduction reaction occurring as shown in block 436. After the electrochromic layer has fully transitioned, the voltage is removed as shown in block 440. Accordingly, the electrochromic layer is in its second optical state as shown in block 442, and electrolyte layer has been transitioned to a second highly stable state as shown in block 441. Since the electrolyte layer is in another highly stable state, there is almost no voltage across the electrochromic device. In this way, the electrochromic device holds the second optical state persistently.

As generally described earlier, the electrochromic device may be designed to hold one or both optical states persistently. A convenient measure for the ability to persistently hold an optical state is to measure the time it takes an electrical device to return to a rest (intermediate colored) state upon shorting the device's electrodes. By directly connecting the electrodes together, any potential generated between the electrolyte and electrochromic layers would immediately and spontaneously cause a current or ion flow. For example, known electrochromic devices, when shorted, returned to a rest state almost immediately. Depending on the device construction and materials employed, the rest state may be completely bleached state, completely colored state or somewhere between the two. For a device where the rest state is intermediate of the two extremes, a fully bleached electrochromic device will turn partially opaque within a few seconds, or a darkened electronic device will become translucent within a few seconds. Using the teachings described herein, the stable electrochromic device is able to maintain its bleached or colored states for extended periods of time, even when its conductors are shorted. Of course, when the electrochromic devices are actually used, the electrodes will not be shorted, but will be connected only through substantial or low impedances. For example, typical impedance between electrodes may be thousands, tens ofthousands, or even millions of ohms of resistance or it may be only a few hundred ohms. Accordingly, measuring the time it takes to return to a rest state when electrodes are shorted may be used as a direct indicator of the time period an optical state may be persistently held. Of course, it will be appreciated that in actual use persistent time periods will change depending upon the impedance presented between electrodes. It will also be understood that temperature and other environmental conditions may also affect or change the rate of return to the rest state. For example, higher temperatures tend to drive the electrochromic material towards a rest state more quickly. Of course, this means that elevating the temperature while testing a shorted device also speeds characterizing the devices persistent time period.

Using the teachings described herein, electrochromic devices have been manufactured and tested to maintain a persistent optical state for weeks, even when electrodes are shorted. For many commercially viable applications, such long term persistence may be desirable. However other commercially viable applications may be enabled with a shorted persistent time period. In this regard, it has been found that devices that are able to maintain a colored or bleached state for more than about eight hours at room temperature with the electrodes shorted have practical commercial application. Another way to test this device would be to increase temperature to about 50° C. or more, and if the device is able to maintain its desired optical state for more that about four hours, then a similar conclusion can be reached. Since transitions occur more rapidly with higher temperatures, when the temperature is about 80° or more, then the same valuable electrochromic device would be expected to maintain its desired optical state for about one hour. It will be understood that other time frames, temperatures, and environmental conditions may be set dependent upon application specific needs.

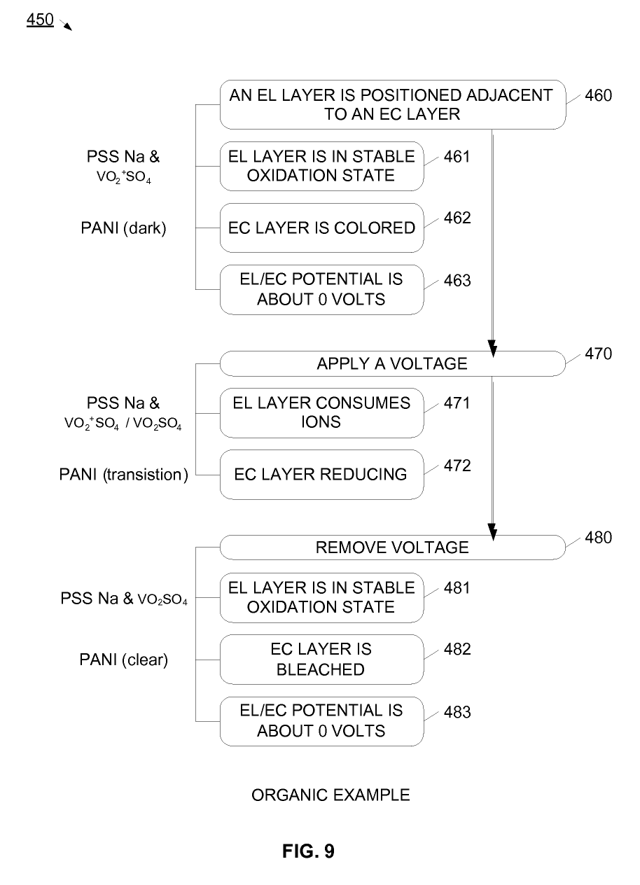

Referring now to FIG. 9, a process for using an organic electrochromic device is illustrated. Process 450 has an electrolyte layer position adjacent to an organic electrochromic layer. The electrolyte layer is in a highly stable oxidation state as shown in block 461. In one example, the stable electrolyte layer is PSS—Na/VOSO₄. The electrochromic layer is an organic PANI as shown in block 462. Since the electrolyte is in a highly stable oxidation state, almost no potential is generated across the device. A reducing voltage is applied to the electrochromic device as shown in block 470. The electrolyte layer consumes ions as shown in block 471, while the electrochromic layer reduces as shown in block 462. After the electrochromic layer is fully reduced, and the electrolyte layer has fully transitioned to a second stable state, the voltage is removed as shown in block 480. The electrochromic layer is now substantially clear as shown in block 402, and the electrolyte layer has now reacted to PSS—Na/VO₂SO₄ (or VOSO₄⁺) which is another highly stable oxidation state. Advantageously, the oxidation state in the clear optical state is even more stable than the state shown in block 461, so the electrochromic device is highly persistent in its bleached state as shown in block 483.

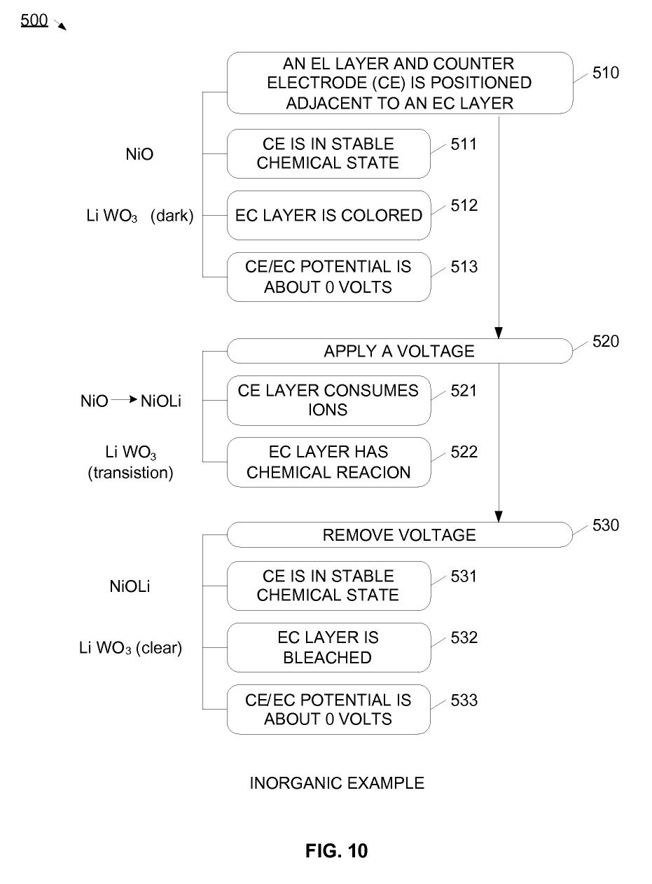

Referring to FIG. 10, and inorganic example is illustrated. In process 500 an electrolyte layer and counter electrode are positioned adjacent to an electrochromic layer as shown in block 510. The counter electrode is in a stable chemical state as shown in block 511. In one example, the counter electrode comprises nickel oxide (NiO). The electrochromic layer is in its dark state as shown in block 512, and may be LiWO₃ Since the nickel oxide is in a highly stable chemical state, almost no voltage is generated, so the electrochromic layer maintains its colored state persistently. A reaction voltage is applied as shown in block 520. The counter electrode layer consumes ions, thereby reacting NiO to NiOLi (or with the hydration associated with the nickel oxide) as shown in block 521. The electrochromic layer also has a chemical reaction which bleaches the electrochromic layer as shown in block 522. After the reaction is complete, the voltage is removed as shown in block 530. The counter electrode has reacted to a highly stable second state of NiOLi as shown in block 531. The electrochromic layer has transitioned to a bleached state as shown in block 532, and since the counter electrode is in a highly stable chemical state, there is almost no voltage across the device. In this way, the inorganic electrical device is able to persistently maintain its bleached state.

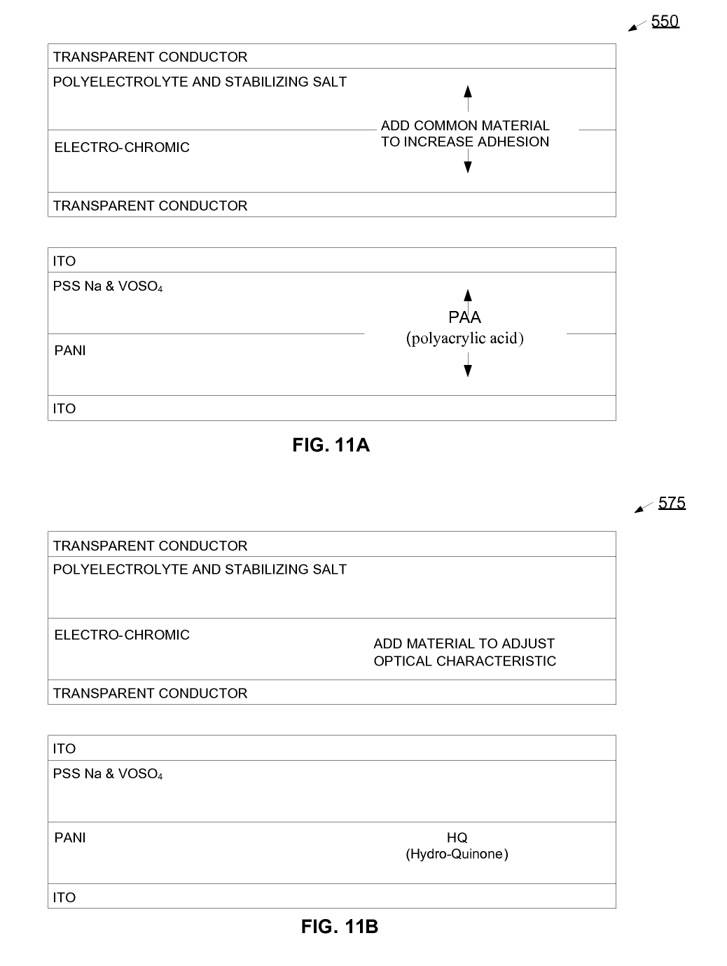

Referring now to FIG. 11A, an electrochromic stack having improved adhesion is illustrated. It has been found that adding a common material to the electrolyte layer and to the electrochromic layer enables the layers to more readily and securely attach. In this way, long-term physical stability is maintained, increasing the useful life of the electrochromic stack. Also, with improved adhesion, the electrochromic stack is less susceptible to separation under physical, chemical, or other extreme conditions. In a particular example, as shown in 560, PAA (polyacrylic acid) is added to both the PSS—Na/VOSO₄ electrolyte layer and to the PANI electrochromic layer. The PAA has been found to substantially increase the adhesive attraction between these layers. For example, adding about 10% of PAA to both layers has been found to provide for more effective adhesion. It will be understood that other acids, and other ratios may be used for specific applications. In a particular process, the PSS—Na is mixed into a solution with an amount of PAA, and the VOSO₄ is also mixed with PAA into a solution. The two solutions are then mixed and combined with a small amount of surfactant to produce a final electrolyte solution. The electrolyte solution is then applied to the PANI using process as previously described. For example, the electrolyte solution may be applied as a spin coat, may be applied using sputtering or deposition techniques, or may be applied using an inkjet or other wet printing techniques. The surfactant was added to the electrolyte mixture to improve spin coating characteristics, and may not be needed with other deposition processes.

Referring now to FIG. 11B, an electrochromic device 575 with adjusted optical characteristics is illustrated. It has been found that certain materials may be added to the electrochromic material to adjust optical characteristics for the electrochromic device. For example, increased transmissive characteristics at particular wavelengths may be desired. As illustrated in block 585, it has been found that the addition of an amount of hydroquinone (HQ) when added to the PANI electrochromic layer produces better optical effects at around 405 nm. For example, a small amount of HQ may be disposed on the surface of the PANI, with excess being removed after a few minutes. The amount of naturally percolated HQ has been found to be sufficient to provide desirable optical characteristics. It will be appreciated that other processes may be used to add HQ. Advantageously, 405 nm is the wavelength used by HD DVD and Blu-ray disc players. Accordingly, the addition of HQ to the PANI layer makes the resulting electrochromic device a more desirable optical shutter for optical media intended to be played in a high definition disc player. It will be appreciated that other materials may be added to the electrochromic layer to specifically adjust the optical characteristics of the electrochromic device.

Optical Device:

An optical device may be constructed using thin films or gels or other materials typically layered or otherwise organized in ways that achieve their desired qualities such as rendering the perceptual (optical) medium accessible or non-accessible by blocking, unblocking, reflecting, polarizing, deflecting, focusing, defocusing, changing the spatial or temporal phase magnitude, affecting the spectral response, inducing a wavelength change of, or otherwise disrupting or interfering with a light source. Furthermore the optical device may e.g. be switchable in a repeatable manner between two stable states: an “open” accessible state and a non-accessible “off” state. Additional intermediate states may also be provided.

The optical devices of particular interest are those whose optical properties change in response to electrical signals and in particular electro-optic devices such as electrochromic (EC) devices. Examples of other electrically activated or switchable devices include: liquid crystals, polymer dispersed liquid crystals, dispersed particle systems, cholesteric liquid crystals, polymer stabilized cholesteric texture liquid crystals. Other examples of electro-optic devices which may also be employed use materials that show a change in refractive index (e.g., potassium dihydrogen phosphate (KDP), ferroelectric materials such as lead- lanthanum-zirconium titanate (PLZT), lithium titanate, barium titanate, polyvinylidene fluoride,) and those employing nanocrystal (or quantum dot) structures and particles where transitions are induced by electrical stimulation. Preferred optical devices have multilayer construction with at least two electrically conductive layers. Although the descriptions herein primarily use electro-chromic examples, it will be appreciated that other electro-optic materials may be used.

The materials used in the manufacture of the optical device may be produced or disposed using conventional film/material deposition processes ranging from sputtering, e-beam, and thermal evaporation to chemical vapor deposition or wet chemical deposition such as printing. In another example, one or more of the materials may be disposed using liquid ink-jet processes. These materials form an electro optical film or stack that may be assembled directly onto a target or product or onto a separate substrate, carrier, or tape for integration with a target product. As discussed later, the electrically switchable optical device may also be combined with other devices that switch from an exposure to stimuli other than electrical stimulus such as heat and radiation (including optical radiation).

Electrochromic (EC) Materials Devices and Their Processing

There are several types of known EC materials which may be used for providing selectable optical states. A description of various standard EC materials is given in U.S. Pat. No. 6,493,128. However, these EC materials as constructed using known processes, need on-going power to maintain a desired state, or else they transition to an undesirable rest stated. As described below, EC materials are selected to interact with another material in an EC stack, and when the EC material is in its desired long-term state, the other material is in a highly stable condition. In this way, there is almost no voltage across the EC device, so almost no leakage current is generated. Therefore, the EC material remains in its desired state persistently.

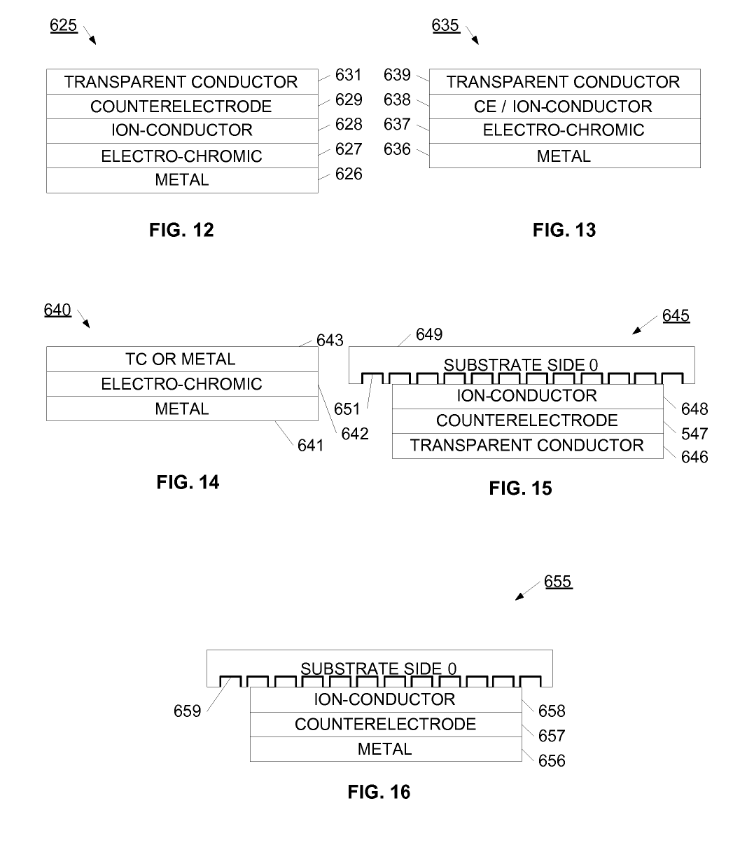

FIG. 12 shows an example construction of a thin film device 625 that uses a metal layer 626 as an electrode and with subsequently deposited layers of EC material 627, ion conductor 628 and counterelectrode 629, and an opposing transparent conductive electrode 631. The device in FIG. 12 may also be fabricated by inverting the layer sequence, where instead of EC layer, the counterelectrode 629 is deposited on the metal 626, followed by the ion-conductor 628 and then the EC layer 627. This construction may be useful, for example, in constructing controllable mirrors or in integrating an optical shutter on to an optical disc.

Metal layer 626 may be made out of any metal or a reflective layer which is optically useful, and as long as it is conductive and electrochemically compatible it could be used as an electrode for EC. Other preferred metals are aluminum alloys (including aluminum/titanium alloys), silver and its alloys, gold, rhodium, titanium, nickel, chromium, antimony and its alloys, tantalum and stainless steel. Of these, preferred aluminum alloys are 2000 series (with mainly copper), 5000 series (with mainly magnesium), 6000 series (with mainly magnesium-silicide) and 7000 series (with mainly zinc). The percentage of the alloyed materials is generally in the range of 0.5 to 3 atomic percent. In aluminum/titanium alloys, the percentage of Titanium is in the range of about 0.5 to 50%. There may also be other added alloying elements in lesser quantities such as chromium, lithium, manganese, titanium, zirconium, iron, lead and bismuth. The preferred alloys of silver are with one or more of neodymium, palladium, gold and platinum. The alloying elements in silver are usually added in a range of less than 3 atomic percent. The preferred stainless steels are 316, 304 and 430.

The conductive electrode layer may not be a single reflective layer but rather it may be composed of several metal layers or a combination of metal and transparent conductor layers. Use of multiple layers avoid the corrosion and electrochemical activity issues of the underlying layers while still being able to use their electrical conductive characteristics. A multilayer conductive electrode may be comprised of a transparent conductor (TC) deposited over a metal layer. Examples of preferred transparent conductors are doped tin oxide, doped indium oxide and doped zinc oxide. Tin oxide may be doped with antimony or fluorine, indium is usually doped with tin oxide (Indium-Tin Oxide (ITO)) or with zinc oxide (called IZO). Another transparent conductor is zinc oxide doped with aluminum oxide (AZO). In ITO and IZO, the atomic percent of tin and zinc is rather high, in the range of 5 to 20% for tin, in the range of 15-50% for zinc, whereas in the other cases the dopant concentration is usually less than 5%. The resistivity of these layers should be as small as possible and for optical media applications less than 100 ohms/square is acceptable. Typically these resistances can be achieved in coatings with a thickness of 50nm or more, where a range of about 50 to 200 nm is preferred. Organic conducting layers may also be used which may be formed using conductive polymers, carbon nanotubes and polyhedrals. The thickness of the metal layers is typically less than 50 nm and that of the TC deposited on the metal is less than 200 nm, preferably less than 100 nm. Multiple metallic layers are used where one of the metal layers serves as adhesion promotion layer between the plastic substrate and the next metal. Some of the adhesion promotion metal layers are chromium and titanium in a thickness of about 5-20 nm. The device concepts here can be adopted for depositing them directly onto a target device, or on separate substrates which are then integrated with the target device. For those devices which are formed separately and then integrated, it is preferred that both of the electronically conducting layers of the EC device are transparent.

In FIG. 12, the EC layer 627 may be an inorganic oxide or a polymeric material. Some of the preferred inorganic oxides comprise of tungsten oxide, niobium oxide, prussian blue, molybdenum oxide, nickel oxide, and iridium oxide and some of the preferred organic polymers are polyaniline, polypyrrole, polyethylenedioxythiophene (PEDOT), polyisothianaphthene and their derivatives. These materials may be amorphous or crystalline. Alternatively, the EC layer may be metallic, for example, aluminum, nickel, or other metal. The ITO (TC) coating may also be used on top of the metal layer as an EC electrode. The thickness of the EC electrode is usually in the range of 100 to 500 nm. These layers may be reduced by injecting them with protons, lithium, sodium, potassium and silver ions along with electrons. The EC layers may also be oxidized by removing these ions and electrons. Tungsten oxide, niobium oxide, molybdenum oxide, polyisothianaphthene and PEDOT color upon reduction whereas others e.g. polyaniline, nickel oxide and iridium oxide color by oxidation. As discussed later one may use both types of EC layers in a device by combining complimentary EC materials i.e., the ones that color upon reduction and those that color upon oxidation. When the device is bleached, both layers bleach and when it is colored then both of the layers color. Organic EC layers may also be formed by taking the organic ion conductors described below and co-reacting or physically trapping organic EC and/or redox materials, such as viologens, amines, ferrocenes, ferrocenium salts, etc.

The ion conductors 628 in FIG. 12 are configured according to the ions which are transported through the electrolyte medium. For example, tantalum oxide is a good proton conductor and lithium niobate, lithium tantalate, lithium silicate, lithium aluminum fluoride and lithium-phosphorous oxynitride (LIPON) are good lithium ion conductors. Sodium β alumina is a good sodium conductor and rubidium silver iodide and silver β alumina are good silver ion conductors. Polystyrene sulfonic acid or other polymeric acid salts of sodium, lithium and potassium are able to conduct either of protons, lithium, sodium and potassium respectively. Some examples are sodium and lithium salts of polystyrene sulfonic acid, polyacrylic acid, polyacrylic and maleic acid copolymers, poly 2-acrylamido-2-methylpropane sulfonic acid (polyamps), etc. Other polymers with sulfonic acid, carboxylic acid moeities may also be used. The above polymers with acid groups (i.e., without the salt formation) may also be used as proton conductors. The conductors may be cation or anion conductors. The thickness of the ion-conductors is about 10 to 5000 nm. Polymeric ion conductors may also be made by adding salts, ionic liquids and plasticers that solubilize salts to any crosslinking or non-crosslinking polymers as long as these are compatible. Compatibility can be easily gauged by transparency of the system, as non-compatible systems will phase separate to a point that they will be opaque or translucent. Such ion conductors may comprise of polyether and polyimine moieties. Preferred polyethers are polyethylene oxide and polypropylene oxide. End functionalized polyethers could be employed to generate crosslinked networks of ion conducting materials. Depending on the functionality coreactants may be required. For example Vinyl, acrylic and methacrylic end functionalities are typically used for curing by UV and thermal processes. One may use coreactants to form urethane, siloxane, epoxy, polyester or nylon bonds. As an example, if the functional groups are polyols one may use isocyanates for forming urethane networks. These will also comprise of appropriate initiators and/or catalysts along with adhesion promoters, oxygen scavengers, additional crosslinkers, etc. These EC devices may also function by the movement of anions rather than cations. Thus the ion conductors may be anionic, such as polymeric quaternary ammonium salts with mobile anions such as trifluoromethylsulfonate (“triflate,” CF₃SO₃), bis(trifluoromethylsulfonyl)imide (N(CF₃SO₂)₂⁻), perchlorate ClO4-, bis(perfluoroethylsulfonyl)imide ((C₂F₅SO₂)₂N⁻)), tris(trifluoromethylsulfonyl)methide ((CF₃SO₂)₃C⁻), tetrafluoroborate (BF₄⁻), hexafluorophosphate (PF₆⁻), hexafluoroantimonate (SbF₆⁻), and hexafluoroarsenate (AsF₆⁻).

The counterelectrodes 69 may be complimentary to the EC electrodes in terms of optical coloration or may show a little or no optical change upon oxidation and reduction. In conventional EC devices the purpose of the counterelectrodes is to store ions which are injected into or ejected from the EC layer when a voltage is applied across the electrodes 626 and 631. These electrodes are also known as ion-storage electrodes. As an example in an EC device that uses an EC layer that colors upon reduction one may use the counterelectrode as another EC layer that colors upon oxidation. Thus when the ions leave the counterelectrode this layer oxidizes (and hence colors) whereas the EC layer also colors as the ions enter this layer and it reduces. Examples of inorganic counterelectrode (CE) materials that do not change their color upon oxidation and reduction are, e.g., are titanium vanadium oxide and cerium titanium oxide. Generally the thickness of counterelectrodes is in the range of 100 to 500 nm. Each of the layers in the EC device may be a single layer of one material or a composite of multiple materials, or they may comprise of multiple layers of different materials. The counterelectrodes may also be organic and their nature oxidizing or reducing is typically opposite to that of the EC electrode. For example a device using an EC electrode of polyaniline which bleaches from a colored state to a bleached state by reduction, would have a counterelectrode which can oxidize. Some of the organic materials for this purpose may be phenazine and hydroquinone and their derivatives. These materials may be incorporated in a solid device by tying them covalently to a polymeric backbone and/or incorporating them in a thermoplastic or a thermosetting matrix. Preferred matrices are polymers which are described in the ionic conductors above. This may be done to increase the ionic conductivity of the layer for faster switching devices. For example CE materials may be made, e.g., hydroquinones mixed with ion conducting polymers as given above, and vanadium or nickel oxide in Li—Al fluoride Some examples of EC materials made by combining ion conductors and EC materials are polyaniline with polyamps, polymeric quaternary ammonium salts or with sodium salt of polystyrene sodium sulfonate, polyacrilic acid and Nafion®, etc. Another example would be tungsten oxide and molybdenum oxide mixed in Li—Al fluoride.

The mobile ions, e.g., protons, lithium, sodium or silver are introduced in the device by co-depositing these with the EC or the counterelectrode (CE), or as a separate layer which is then intercalated into the EC or the counterelectrode, or by chemical or electrochemical reduction. The various layers in the EC device may be deposited by physical vapor deposition (PVD), chemical vapor deposition (CVD) or by wet chemical processing (spinning, dipping, spraying, ink jet printing including patterning of solutions). PVD includes reactive sputtering of metals, radio-frequency or pulsed DC sputtering of non-conductors (e.g., oxides), thermal, laser and e-beam evaporation. These processes may also be assisted by plasma and ion treatments. Lithium is difficult to co-deposit by sputtering or evaporation of lithium metal due to its high reactivity. A preferred method is to use an alloy of lithium and aluminum for evaporation or sputtering. This results in a preferential removal of lithium from the target, and oxygen in the processing chamber is bound by aluminum. In another alternative tungsten oxide comprising oxide materials may be deposited by sputtering in an argon atmosphere which leads to films in the reduced (or colored) state.

Irreversibility or limited cyclability may be introduced to the point of only allowing the device to change once before it locks in the change permanently by several means. One may use a counterelectrode which does not result in reversible change, e.g., zinc oxide, tin oxide, silica, alumina, etc., when intercalated with protons or lithium or causing irreversible chemical/electrochemical changes. The intercalated ions may be made irreversible with time as they bind or react slowly within the host layer. Since these materials are not known to intercalate these ions, such ions may nevertheless be inserted by applying high voltages, i.e. in excess of 2V and preferably in excess of 2.5V and most preferably in excess of 3V. Most EC devices in this disclosure will operate in the range of 0.8 to 6V. These will be called ion-reactive layers as they react with the ions and then do not release them.

The ion-reactive layers may be formed from organic and organometallic materials. These ion-reactive layers may be used as counterelectrodes or even as irreversible ion traps located between the EC and the ion conductor layer. Silanes, such as epoxy silanes, amino silanes, mercapto silanes, methyl tetraorthosilicate, etc. may be used to form these layers. Silanes may be deposited from about 1% solutions in ethanol or methanol. Water or acids may also be added to pre-hydrolyse them. As an example this layer may be added between the EC layer and the ion conductor or be substituted with the ion conductor or be located between the counterelectrode and the transparent conductor. It was found that when using tungsten oxide as the EC layer, the silane coating allowed the ions to go through to color the EC layer, but was more difficult to bleach. Ion-reactive layers to trap lithium may also be made which comprise of crown ethers. Crown ethers are molecules which have cavities of just the right size to trap ions or molecules. Thus, appropriate crown ether should be one that can trap lithium. A crown ether suitable for trapping lithium has a cavity size of about 0.085 nm such as 15-crown-5 (15C5) available from Sigma Aldrich (Milwaukee, Wis.). To form a layer comprising crown ethers, these crown ethers may be mixed with the silanes or introduced in matrices of polyethylene oxide and/or polypropylene oxide or other ion-conducting polymers described above. In one method polypropylene glycol may be mixed with crown ether and a curing agent based on an epoxy or an isocyanate. This mixture is deposited by spin coating or other method and cured (e.g. cross-linked) into a solid film. In some example constructions, formulations may be made, which are UV cured, by using polypropylene glycols which are terminated by methacrylic or acrylic groups (including epoxy and urethane acrylates), adding UV initiators and curing them after deposition. One may also use alternative formulations which are solidified upon cooling (commonly called hot glue) or those materials which are processed like hot glue to give immediate green strength for handling, but can be further cured by UV or by mechanisms using room-temperature vulcanizates (RTVs). For trapping ions one may also use materials that get reversibly or irreversibly reduced, e.g., peroxides, disulfides, manganates, chromates and dichromates, etc, which may be also put in the matrices as are crown ethers.

The development of an electrochromic device which is stable in both the dark and bleached form requires a fine tuning of the half cell potentials of redox species. The bleached oxidizing agent and reducing agent must result in a cell potential of less than of equal to zero. This can generally be calculated using the Nernst equation. However, in the search for a device which is stable in both the bleached and dark state the cell potential for the reverse reaction must also be less than or equal to zero. Such a set of oxidizing agent and reducing agents is required for such as system.

An alternative approach to this system is to select either the oxidizing agent or reducing agent to undergo an irreversible reaction. This will prevent any possibility for the establishment of a galvanic cell upon electrochemical switching. This will of course produce a single use electrochemical device. Simple examples would include chemical species which converted to gasses or are precipitated upon undergoing the redox reaction. In an electrochromic device such reactions are not practical, other systems must be considered. Systems which undergo a chemical change through the addition or removal of an electron are desirable. Such systems may undergo dimerization or polymerization, add a ligand or undergo a significant structural change.

Electrochemical polymerizations are generally employed to produce conducting polymers. However, use of the monomers as the reducing agent in an electrochemical cell should produce an irreversible electrochemical device. Pyrroles, thiophenes, anilines and furans have all been shown to undergo electrochemical polymerization. The oxidizing potential of the monomer can be controlled by relative electronegativity of the monomer. Careful selection of the monomer will enable development of an electrolytic cell where there is no possibility of forming a galvanic cell after a potential has been applied

Other possibilities involve a chemical change such as the formation of bonds in the thiol to disulfide conversion. Others would involve a geometric change in a metal complex, such as a tetrahedral to octahedral change in geometry. Many examples of complexes which undergo such changes are know, examples include Cu(I)→Cu(II) and Co(II)→Co(III). In inorganic chemistry other systems where a change in the coordination sphere occurs on oxidation or reduction. Examples include species where oxide ligands leave or enter the coordination sphere such as MnO₂→Mn²⁺, VO₂⁺→VO₂⁺.

Electronic leakage through the device can be controlled by the choice of ion conductor, one such choice is use of ionic layers in between the EC and the inorganic ion conductor or as a replacement of the ion conductor. Examples of ionic layers being poly(sodium 4 styrene sulfonate) and poly(lithium 4 styrene sulfonate), polyamps, Nafion™ and ionomers (e.g., Surlyn® from Dupont (Wilmington, Del.)). These materials are generally described in U.S. Pat. No. 6,178,034. For EC devices where they are activated to a bleached state, and it is desired that this state be maintained for a limited time (few hours to a few days or even weeks), reversible type EC devices are preferred. These devices can be made to revert back to a more colored state by manipulating the ion-conductor so that it has a finite electronic conductivity. Alternatively, the two electrodes may also be joined by a high resistance element in excess of about 100,000 ohms to tune the desired amount of “open state” time. Typically, a thinner ion conductor will have lower electronic resistance, thus more leakage current. Also the microstructure of the ion conductor may be manipulated, e.g., a given ion conductor when deposited in a more dense form will have lower ionic conductivity if the other parameters are held constant. Even with devices with no driving potential, color may be lost because of oxidation, particularly for those layers where coloration occurs in reduced state. Processing conditions, e.g., sputtering or evaporation under high pressures leads to higher porosity, use of elevated temperatures and use of ion-assisted deposition reduces porosity. One may also use materials which are colored in oxidized state, and these can be bleached, but over time revert back to the colored state due to oxygen diffusion in the product, an example of such EC material is polyaniline. It is preferred to encapsulate the EC devices with barrier layers so that permeation of oxygen and water is significantly reduced. Further, these materials may also lend to increased surface hardness. Several of these coatings are listed in other section where hard coats are discussed. Preferred permeation of oxygen or water through these layers at room temperature should be less than 3×10⁻⁵ ml/cm²-day-atmosphere and less than 8×10⁻⁵ g/cm²-day at 90% relative humidity respectively. When EC layers, ion conductors and the counterelectrodes are deposited by physical vapor deposition, it is preferred that they have sufficiently open structures for ions to go through and have low stresses. For example, EC coating porosity is dependent on the ion to be transported. For example, the lithium ion (Li⁺) has a size of 0.076 nm and O²⁻ has a size of 0.145 nm (and O₂ is about 0.17 nm). The channel size should preferably be greater than about three times the ion diameter. Typically low density or more porous structures are produced at higher vapor pressures (keeping the other factors constant). Pressures in the range of 10⁻³ to 5×10⁻⁵ torr are generally preferred. The pressures are usually controlled by using oxygen, nitrogen and/or argon. A method to deposit organic layers or inorganic layers from liquid precursors is by printing of which a preferred approach is by using ink-jet printing techniques, or any other printing techniques including screen printing, offset and gravure printing methods. Several companies offer capabilities of ink jet printing on rigid substrates such as Litrex (Pleasanton, Calif.), Dimatix (Santa Clara, Calif.) and Microfab Technologies (Plano, Tex.). A combination of processes may be used to deposit multilayer devices, i.e., some by printing and the others by PVD or CVD. PVD is mainly used for metals and inorganic materials. However, increasing use of printing including ink-jet printing is being done for these materials. Typically nano-sized particles of metals or inorganic particles is dispersed in a liquid medium and used as ink. The particle sizes are generally less than 100 nm and more in the range of 5 to 20 nm. As an example formation of such particles in liquid phase are described in U.S. Pat. No. 6,322,901 and published US patent application 20050107478. Liquids comprising nano-particles of inorganic transparent conductors (such as ITO and IZO) and metals can be used for printing. For example Cabot (Billerica, Mass.), ULVAC Technologies Inc (Methuen, Mass.) and Harima (Japan) have nano-metal pastes (e.g., gold, silver, copper, etc) for printing. Also, the RF antennas as described later may also be printed (e.g., using ink jet printers) using these inks on the same substrates as the EC devices.

Transparent conducting oxides may be deposited by a number of methods. Preferred methods are those where these oxides may be deposited at high rates to keep up with rates similar to metal deposition in optical media to balance the throughput and minimize the number of discs going through the process at any given time. It is preferred that each layer of the conductive oxide or any other layer in the conductive stack is deposited at about less than 15 seconds, and more preferably in less than 5 seconds, and two to three seconds being most preferable. These are deposition times only and not the period for evacuation through load-lock ,etc. Further, since a substrate may be made out of plastic (for example polycarbonate), it is preferred that the substrate temperature is at least 10 C below the glass transition temperature of the plastic material. For polycarbonate substrate a preferred range is below 130 C, and more preferably below 110 C, and most preferably below 100 C. One preferred method is to use Pulsed DC sputtering for high flux and simultaneous use of an auxiliary oxygen plasma when using an alloy target of the component metals (e.g., indium-tin or indium zinc, etc). The auxiliary plasma can be generated by radio frequency (e.g., 13.56 MHz) or by the use of microwaves. An example of pulsed DC power supply is Pinnacle Plus available from Advanced Energy (Fort Collins, Colo.). A ceramic target may also be used but one has to be careful about the thermal loading. To get high flux in a small area where the coating is to be deposited, hollow cathodes may be used rather than planar cathodes. The material is sputtered through an inner diameter of the target tube and the atoms exit from the end of this tube. This type of system also has high coating efficiency as very little material ends outside the desired coating zone. An important parameter is to achieve a high flux of ions with energy closer to about 20 eV/ion so that dense crystalline films are formed without being disturbed too much from the kinetic energy of the arriving ions.

For the access control, security, and theft protection, the most desirable EC device could maintain its colored and bleached state without having an appreciable potential in either state. This means voltages in any state of coloration should be lower than 0.5V and preferably less than 0.1V and most preferably zero volts. Thus these devices will have low or no internal driving potential which may lead to stable optical characteristics when stored for long periods of time. It is best to have devices exhibit this characteristic at all temperatures to which the target device is to be subjected to. FIG. 13 shows an EC device 635 with four layers. The metal layer 636, EC layer 637, and the transparent conductor 639 are similar materials as described above with reference to FIG. 12. The ion-conductor 638 is used as a material that serves both as the electrolyte and as a material that can absorb the ions from the EC layer when powered. The layer 638 should not become electronically conductive when oxidized or reduced. Since, this does not have an electrode symmetry these can more readily form non-reversible devices. These devices can also be driven at high voltages where the ions react with layer 638 or even partially reduce the transparent conductor. Examples of such layers are those comprising silica, tantalum oxide, zirconium oxide, alumina and yittria. Since these materials 38 are non-conductive they are not expected to have any potential between the electrodes which will cause the ions to move away from or move into the EC layer. In the bleached state the ions react permanently, thus there is no driving force for the devices to become colored when the device is left standing without any applied potential. The EC layer may be reduced or oxidized in any one of the ways to obtain the initial coloration as described above. The CE layer may also be formed by using the organic or inorganic ion-conducting materials with irreversible or reversible redox materials.

One may also make the device in FIG. 13 in an inverted sequence where counterelectrode layer 638 is first deposited on the metal electrode 636 followed by the EC layer 637 and then the transparent conductor 639. FIG. 14 shows another type of EC device 640 (thin film stack) which can be used for this purpose. In these devices those EC materials 642 are preferred that do not become conductive in either their colored or bleached states and thus do not cause a short between the two electrodes. The metal 641 and the transparent conductors 643 are similar as described above. Some of the preferred EC materials are nickel oxide and molybdenum oxide. To bleach (when a potential is applied) the ions are irreversibly driven into the metal layer or the transparent conductor. When ions are driven in the transparent conductor, its conductivity may be reduced to a point that the device in non-operational after this change. One may add an insulating layer between the EC layer and one of the electrodes to ensure that there is no electrical short in the device this may be a thin layer of silica, zirconia, alumina, yittria or tantala in a thickness range of less than 50 nm.

There are other types of EC materials that may also be used where the metal layer itself participates in an EC reaction in going from transparent to reflective or vice versa. U.S. Patent Publication 20040021921 describes examples of these EC devices. Antimony/bismuth and silver-antimony, copper-antimony and antimony layers are preferred metals for this application where the metallic (reflective) state goes to a transparent state when injected with lithium. Further, the preferred range of antimony concentration (atomic %) in these alloys is from about 40% to about 90%.

In one example, the stable electrochromic device is integrated on to an optical media. However, it will be understood that other fields of application exist, for example, in the automotive, medical, entertainment, security fields. It will be understood that specific processes, materials, and optical characteristics may be selected according to application requirements. Optical disc devices may be constructed as shown in FIG. 15 and FIG. 16. For example, the device 645 may be constructed as in FIG. 15, where the metal layer 651 is deposited on substrate 649. Further this metal layer is one of those metal compositions that changes from reflectance to the transparent state, then preferred thickness of less than 50 nm and a more preferred thickness is less than 30 nm. The electrolyte 48 is a lithium conductor such as lithium niobate, lithium tantalte, lithium silicate, lithium aluminosilicate, and lithium-phosphorous oxynitride (LIPON) in a thickness of about 50 to 500 nm. The counterelectrode 647 is a material that is transparent in its reduced state, example being lithium doped cerium-titanium oxide, lithium doped titanium vanadium, lithium aluminum fluoride doped with oxides such as titanium oxide and molybdenum oxide may also be used in a thickness range of about 100 to 500 nm. This is followed by a transparent conductor layer 46 as described before. In these devices lithium is inserted into the counterelectrode in several ways as described above, such as co-deposition, chemical or electrochemical reduction or depositing lithium as a separate layer which is then diffused in the CE by heat, time or by applying a mild potential across the electrodes. If this metal 651 is the same as a reflective layer in the optical media, then this layer (in the active EC device region) is lithiated by inserting the lithium ions so that it becomes transparent. Thus in the transparent state (which will be closed state for this device) the data is not read in Layer 0 as the reading laser beam passes through. When this layer is subjected to a positive potential compared to the transparent electrode then the lithium is driven out and it becomes reflective to an extent that there is sufficient reflection from this layer to read the data and also transmit enough laser power to be able to read underlying layers.

One may also invert the layers for the device 655 as shown in FIG. 16 which also uses two metal layers. Metal 656 is the gold layer, and metal 659 is the metal layer which changes from the transparent to the reflective state deposited on the substrate, and the description of the ion conductor 658 and the counterelectrode 657 remains the same as in FIG. 15. This type of an EC device may also be put on the readout side of layer 1 starting with a metal layer 659 such as gold in FIG. 16. All the other layers are subsequently deposited and the EC metal layer 656 is deposited in the EC active region so that it could change from transparent to reflective. The counterelectrode 657 may contain the lithium incorporated in one of the several ways discussed above. The device when activated will cause the lithium to be injected into the reflective layer 656 in the EC device area to be clear and be able to read data. When Lithium is expelled it becomes reflective to the point that either none of the reading laser intensity passes through it and is unable to read data on any of the layers masked by the EC layer, or changes to a reflective state which is so poor that even the data on the readout side of Layer 0 is unreadable.

Another example optical device uses at least two electrodes with a polymer comprising electrolyte in between. Preferably these are two of the metal layers used for data layers. If the data layers are the two halves of the disc as shown in FIG. 1, the bonding agent may serve as the electrolyte or will have electrolytic components in the device region. The electrolyte may comprise of an electrochromic material which may be anodic, cathodic or may have both of these characteristics. Some of these materials are described in US patent applications 2003/0234379, 2004/0257633 and in U.S. Pat. No. 6,853,472. In an example EC device, a pH change is activated (acidic or basic) directly in the electrolyte layer, causing one of the metal (i.e., electrode) layer to gradually dissolve away making the data on that electrode (layer) unusable. This dissolution may not be a physical dissolution, but dissolution by creating a more soluble metal species (or metal compound) formed as a result of the electrochemical reaction. The formation of this chemical compound may not be reversible. In solid devices the kinetics of forming solid solutions may be so low, that the optical transition may be observed only due to the formation of the new metal compound which is more transparent. In general, the EC layer (metal in this specific case) may be porous where the electrolyte penetrates these pores in addition to forming a layer on top of the EC layer. Porosity can allow for a faster interaction between the two layers. The electrolyte although is a solid may have liquid or flexible components which plasticizes the electrolyte matrix and allow faster kinetics. One may further add reactive materials to the electrolytes where this pH change causes them to change their optical properties Further these property changes may also be aided by moisture and/or oxygen diffusion into this layer from the ambient atmosphere. As an example if the data layers are aluminum and gold as the two electrodes forming the EC device, the aluminum will corrode due to an oxidation reaction caused by pH change as given by the following scheme:
Al→Al⁺³+3e⁻ and Al⁺³3OH⁻→Al(OH)₃
The change to Aluminum hydroxide causes loss in reflection. The oxidation reaction in the electrolyte in acidic medium (pH lower than 7) leads to the following balancing reaction where hydrogen will escape through the package
2H⁺2e⁻→H₂
and in basic medium (pH higher than 7) may lead to the following balancing reaction in the electrolyte
O₂+2H₂O+2e⁻→4OH⁻

Other redox additives may also be added to the electrolyte which will lead to alternative balancing reactions. The electrolyte will also comprise polymeric, monomeric or oligomeric components (e.g., acrylates and methacrylates including urethane and epoxy acrylates). The layers are typically put down from a liquid or a vapor precursor. Solid layers are obtained by polymerization of the material in the layer or evaporation of a solvent. The curing or polymerization may be done by radiation (UV, microwave, etc.) and or heat. Depending on the mechanism of cure appropriate initiators may also be added as commonly known in the art. One may also use alternative polymeric formulations as a matrix which are solidified upon cooling (commonly called hot glue) or those materials which are processed like hot glue to give immediate green strength for handling, but can be further cured by UV or by mechanisms using room-temperature vulcanizates (RTVs).

In the above description it was assumed that the EC is located between the two halves of the DVD. Another highly preferred location is outside of the DVD on the read-out side (see FIG. 1). The thickness of the EC device (including conductive layers) is preferred to be less than 10 microns, more preferably less than 5 microns and most preferable less than 2 microns. The EC device may be covered by a clear hard coat which could be deposited by liquid precursors or from vapor phase such as PVD and CVD and may be assisted by plasma energy. The preferred thickness of the hard coat is from 0.015 to 10 microns. Silicon, zirconium and aluminum containing materials are preferred for the hard coating. Preferred examples are silica, zirconia and alumina. The hard coats may also be deposited by liquid processes (e.g., spin coating) that form crosslinked polymers, typically acrylates and/or silicones. These may be crosslinked using thermal or radiation (such as UV) activation. These may also comprise of hard nano-particles (typically 5 to 50 nm in size) , some of these are metal oxides such as silica, alumina and zirconia. An example is a spin coatable hard coating from TDK (Japan) is DURABIS PRO such as PD-RE23CN. Hard coats deposited by plasma processes from chemical vapors are also available from Exatec (Wixom, Mich.) and Schott-HiCotec (Elmsford, N.Y.). These hard coats also provide the barrier against moisture and oxygen permeability.

### EXAMPLES OF EC MATERIALS AND DEVICES

### Example 1

### EC Device with MoO₃+AlF₃ Counterelectrode Processed by PVD

A set of four EC devices were fabricated on a conductive tin oxide coated glass by depositing coatings using physical vapor deposition (PVD). This was a five layer device similar to the one shown in FIG. 12 comprising of an EC layer, ion conductor and a counterelectrode sandwiched between two conductors. The devices were appropriately masked from each other to generate four independent devices in a size of about 1.5 cm×1.5 cm. The first layer was 500 nm tungsten oxide evaporated by an electron beam. Then 60 nm thick lithium metal was evaporated to dope and reduce tungsten oxide to its colored bronze (corresponding to about 24 mC/sq.cm of charge). An ion conductor comprising aluminum fluoride and lithium was deposited next in a thickness of 500 nm. This was followed by a counter electrode comprising about equal proportions of molybdenum oxide and aluminum fluoride in a thickness of 100 nm and the top conductor which was 9.5 nm thick gold layer. The device as fabricated was colored and when 1.5V was applied (gold electrode being negative) the device bleached. The colored transmission at 650 nm was 4.4% and bleached transmission was 20.5%. This was a reversible device. In a separate experiment the transmission of a 9.5 nm gold coating on glass was measured to be 42% at 650 nm.

### Example 2

### EC Device with NiO Counterelectrode Processed by PVD

Another set of devices was fabricated as in Example 1. however, in this case the counterelectrode was 120 nm thick nickel oxide. At 650 nm, this device in colored state was 2.6% transmitting and in the bleached state the transmission was 15.1%. The colored state transmission at 405 nm was 6.9% and 22.6% when bleached. This device could be reversed.

### Example 3

### Electrochromic Polyaniline (PA) Coating

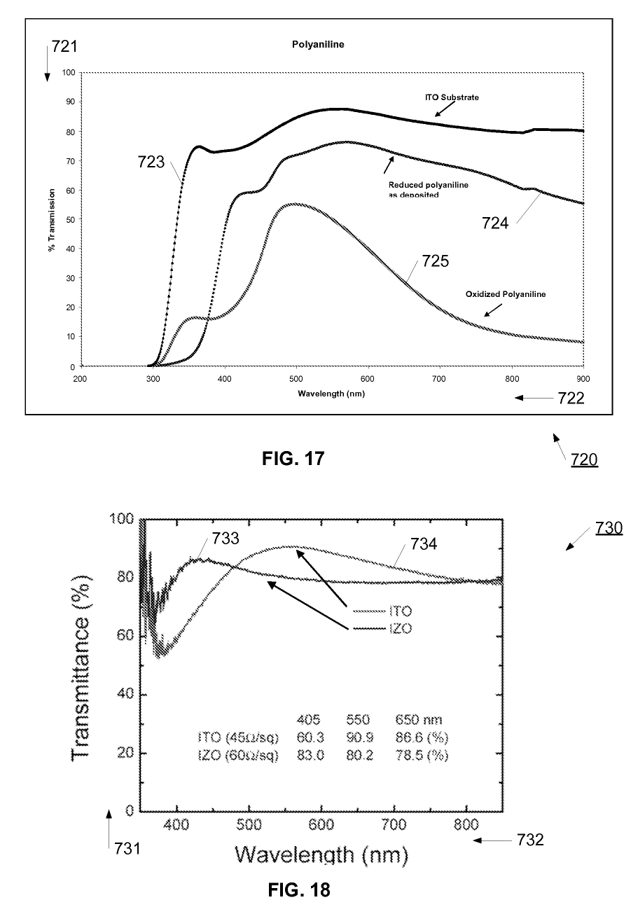

PA was deposited on ITO coated glass. The coating was deposited from a solution comprising formic acid and ascorbic acid. The coated substrate was heated to 70° C. for 15 minutes to remove the volatile products and solidify the coating. The 300 nm thick coatings were colorless as produced and were electrochromic as shown in FIG. 17 and the table below. FIG. 17 has a graph 720 that shows a % Transmission 721 versus wavelength 722 for the ITO substrate 723, the reduced PA 724, and the oxidized PA 725.

| % Transmission at | | |
|---|---|---|
| 650 nm | 550 nm | 405 nm |

Polyaniline

| | | | |
|---|---|---|---|
| Bleached | 71.6 | 75.8 | 52.8 |
| Colored | 28.7 | 50.0 | 18.2 |
| ITO substrate only | 84.0 | 87.7 | 73.4 |

### Example 4

### Transparent Conductor Coatings for the EC Devices

Two type of coatings, Indium tin oxide (with about 0.1 as tin to indium atomic ratio) and indium-zinc oxide (with about 0.3 zinc to indium ratio). These coatings were deposited on glass without heating. These coatings were deposited by sputter coating process in a thickness of about 100 nm at temperatures lower than 100 C. The resistivity of ITO was 45 ohms/square and of the IZO 60 ohms/square. Their optical transmission spectra are shown in FIG. 18. FIG. 18 has a graph 730 that shows a % Transmission 731 versus wavelength 732. It appears that for devices using light sources at 405 nm, IZO 733 will be preferred over ITO 734 from an optical perspective. In FIG. 17, the transmission of ITO was high at 405 nm indicating that the transmission of this layer is also morphology dependent which for a given composition can be controlled by the processing parameters.

### Example 5

### Solution Deposited Tungsten Oxide Coating Reduced with Protons

A tungsten oxide coating on ITO (12 Ω/sq) was prepared from a precursor solution. The precursor solution was prepared from 3 grams of peroxotungstic ester (PTE) dissolved in 30 mls of ethanol. The solution was spin coated at 1000 rpm onto ITO and cured under humid conditions to 135° C. The WO₃ coating had a thickness of 250 nm. This coating was chemically reduced to a colored state by subjecting this to dilute sulfuric acid and indium metal.

### Example 6

### Ion Conducting Layer Cured by Radical Polymerization using UV Light

A UV curable solid electrolyte was prepared by mixing 3.75 g of poly(propylene glycol) diacrylate with 1.25 g of poly(propylene glycol) acrylate and 0.2 g of the UV initiator Irgacure 500 (supplied by Ciba Speciality Chemicals Corp. White plains, N.Y.). To enhance the ionic conductivity of the mixture 0.77 g of 1-Butyl-1-methylpyrrolyidium 1,1,1-trifluoro-N-[(trifluoromethyl)sulfonyl]-methanesulfonamide ionic liquid and 0.16 g of lithium trifluoromethanesulfonate. A thin coating of the mixture was cured to a solid film by exposing this for 5 seconds in a Xenon strobe light curing system (Model 550 from Electro-lite Corporation (Danbury, Conn.)).

### Example 7

### Ion Conducting/Electrochromic Layer Cured by Cationic Polymerization using UV Light

A cationically cured cathodic layer was made using the following:
4 g of epoxy resin CyracureUVR-6105 (Dow chemical, Midland, Mich.)
0.717 g polypropylene polyol Voranol PT700 (Dow Chemical, Midland, Mich.)
0.189 g photoinitiator UV1 6976 (Dow Chemical, Midland, Mich.)
0.024 g silicone surfactant Silwet L-7604 (GE silicones, Scnechtady, N.Y.)
1.488 g 1-Butyl-1-methylpyrrolyidium 1,1,1-trifluoro-N-[(trifluoromethyl)sulfonyl]-methanesulfonamide ionic liquid (or salt)
0.493 g diethyl viologen 1,1,1-trifluoro-N-[(trifluoromethyl)sulfonyl]-methanesulfonamide as the EC material
   This formulation was spin coated at 2000 rpm and cured under the Lesco Rocket Cure system (Torrance, Calif.) for approximately 60 seconds forming a 9 microns thick film. When this formulation was diluted with methanol much thinner coatings were prepared. These coatings were cured after methanol evaporated. When viologen salt was left out from the formulation, ion conducting coatings were obtained.

### Example 8

### Ion Conducting Layer Containing REDOX Species Cured by Radical Polymerization using UV Light

A UV curable solid electrolyte was prepared by mixing 3.75 g of poly(propylene glycol) diacrylate (Mol wt. 540) with 1.25 g of poly(propylene glycol) acrylate (Mol wt 475) and 0.5 g of dipentaerythriol pentaacrylate ester and 10 g of amine modified acrylate oligomer, acrylic ester. 0.4 g of the UV initiator Irgacure was added. 0.06 g of glycidoxypropyltriethoxysilane was added as an adhesion promoter. To enhance the ionic conductivity of the mixture 0.246 g of 1-Butyl-1-methylpyrrolyidium 1,1,1-trifluoro-N-[(trifluoromethyl)sulfonyl]-methanesulfonamide salt and 0.046 g of lithium trifluoromethanesulfonate salt were added. The redox species ferrocene was added in a concentration of 0.282 g. This mixture was spin coated on glass and cured for 5 seconds in a Xenon strobe light curing system (Model 550 from Electro-lite Corporation (Danbury, Conn.)). The film thickness was 9 μm

### Example 9

### Electrochromic Device with Tungsten Oxide UV Cured Layers and Gold Electrode

A thin layer of the ion conducting material describe in Example 8 above was spin coated at 1000 rpm onto tungsten oxide as described in Example 5, but without the reduction step. The ion conducting layer was cured under UV to give a solid layer 9 microns thick. On top of this layer was deposited 50 nm of gold by a sputtering process to complete the stack and form the top electrode. The cell had an initial reflectivity of 68% at 650 nm and when colored by applying 3.5 volts had a reflectivity of 31%.

### Example 10

### Laminated Solid State Lithium Electrochromic Device

A solid state electrochromic device was constructed using a tungsten oxide coating as described in Example 5 above except the WO₃ was cured at 250° C. and the coating was reduced in a three electrode configuration using 0.1M lithium trifluoromethanesulfonate and 0.05M ferrocene in propylene carbonate as the electrolyte. The reference electrode was a silver wire. The reduced WO₃ on ITO was laminated with another ITO coated substrate through use of the ion conducting layer as described in Example 6. This bonding layer was cured under UV and had a thickness of around 30 μm. The initial transmission of the cell at 650 nm was 55% and when bleached at 3.5 Volts at room temperature its transmission increased to 80%. This cell in the bleached state along with another cell in the colored state (50% T at 650 nm) were stored at room temperature for three days without applying any electrical power. Both the cells did not show any optical change. To see if elevated temperature storage would accelerate a change in optical properties, both of these cells were then subjected to 85° C. for six days without power application. Again no change in optical properties was observed with no change in its optical transmission. This shows that in both cases the optical states were maintained without applying any electrical power.

### Example 11

### Laminated Solid State Proton Electrochromic Device

An electrochromic device was prepared as described in example 10 above except that the WO₃ layer was cured at 135° C. and reduced with protons using dilute sulfuric acid and indium metal. The cell at 650 nm had a transmission of 3% and when bleached at 4.0 volts had a transmission of 78%. This cell was placed in the bleach state at 85° C. for six days with no change in transmission or physical appearance of the cell.

### Example 12

### Thin Film EC Device with UV Cured Electrolyte

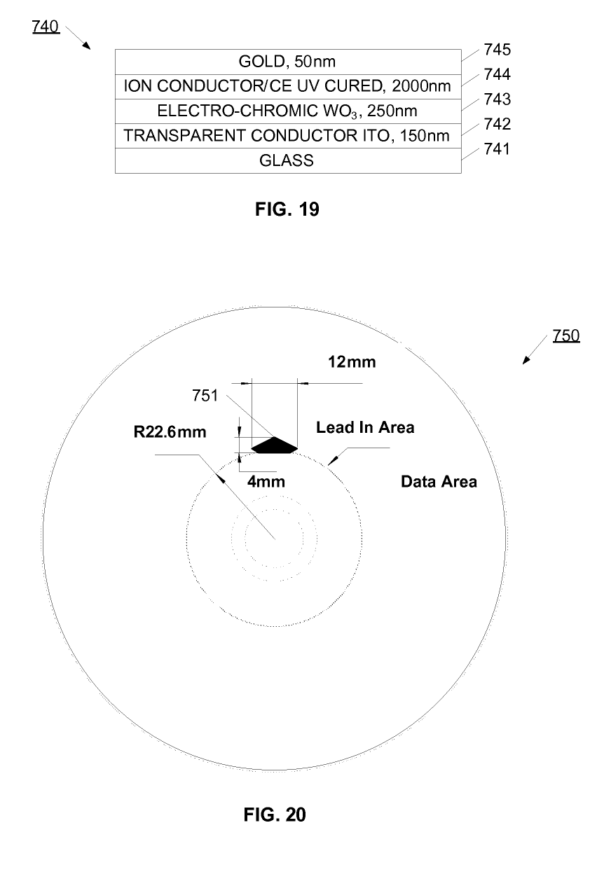

An electrochromic device 740 was made by depositing thin layers as shown in FIG. 19. The substrate used was glass 741, but it could have been a DVD substrate such as polycarbonate. ITO layer 742 was 150 nm thick with a conductivity of 15 ohms/square. This was followed by 250 nm tungsten oxide layer 743 which was deposited and reduced by the method described in example 5. The ion conductor layer 744 was formed by using a standard DVD bonding adhesive Dicure Clear EX 7000 (from Dinippon Ink and chemicals, Japan) and mixing this with 01M 1-Butyl-1-methylpyrrolyidiuml,1,1-trifluoro-N-[(trifluoromethyl)sulfonyl]-methanesulfonamide (ionic liquid or salt) and 0.1M 15-crown-5 ether. The thickness of this layer was 2 μm, followed by a top gold electrode 745 in a thickness of 50 nm. Gold could also have been replaced by a transparent conductor in about the same thickness. This device was colored blue as observed in reflection through the clear substrate. When a potential of 3V was applied to the device (Gold being negative compared to the ITO) the device bleached.

### Example 13

### EC Device on a DVD

FIG. 19 shows a DVD 750 with an EC device 751 in the shape of a truncated diamond. This EC device 751 was made by physical vapor deposition of several layers as shown below on the outside surface of a pre-bonded DVD.
Disk (Polycarbonate)/ITO(1)/LiNiO/LiALF₄/WO₃/ITO(2)
ITO(1): 100 nm
NiO: 100 nm
Li: 10 mC/cm2
LiAlF₄: 750 nm
WO₃: 300 nm
ITO (2): 50 nm
   The device could be colored or bleached by applying 1V. For coloration ITO(2) was negative, and the polarity was reversed for bleaching. In the colored state the DVD did not play on a computer DVD player. In the bleached state the DVD played normally.

### Example 14

### EC Device with High Stability in Colored and Bleached State

A device was made using two pieces of glass with ITO coatings. On one of these a polyaniline coating in a thickness of 700 nm was deposited on a spin coater at 200 rpm as described in Example 3. This was assembled in a cell with a liquid electrolyte comprising of propylene carbonate to the ionic liquid in a ratio of 4:1 and 0.25 molar hydroquinone. The ionic liquid was 1-Butyl-1-methylpyrrolyidium 1,1,1-trifluoro-N-[(trifluoromethyl)sulfonyl]-methanesulfonamide and the other side being ITO on coated glass In principle the cell resembled FIG. 13 where the EC layer was polyaniline. The electrolyte thickness was about 70 microns. The transmission of the cell at 650 nm was 2%. The two transparent electrodes of the cell were shorted. There was no change in the cell optical properties for several days. The potential between the two electrodes was negligible. When a potential of 2V was applied with polyaniline side of the cell being negative, the cell transmission changed to about 30% in 7.5 s. After bleaching the cell was shorted again. The transmission of the cell relaxed by a couple of percent to about 28% and then it did not change for several days. The potential between the two electrodes was not measurable (close to 0V) in this state.

### Example 15

### Polyaniline Coatings Inside the DVD and Playability

Several DVDs were coated with polyaniline solutions (see example 3) by spraying through a mask to create a pattern as shown in FIG. 19. These patterns were created before the two halves of the DVD were bonded. The patterns were put directly on the metallic layer of the L0. In one case the transmission of the coating was 1% and in another case the coating was bleached with a transmission of 47% at 650 nm. The transmission measurements are reported by putting similar coatings on glass and measuring the transmission of the coated glass. The two halves i.e., coated L0 and non-coated L1 were bonded by a UV curing glue from DiNippon Ink (Japan) used for this purpose. Glue thickness was about 40 microns. The one with the colored pattern did not play on any of the following players and the bleached one played on all of these.

| | | |
|---|---|---|
| Panasonic (Japan), | Sony (Japan), | +HL,19 |
| Model | Model | CyberHome (Fremont, CA), |

| | | |
|---|---|---|
| DVDS29S | DVPNS50PS | Model CH-DVD500 |

### Example 16

### Polyaniline Doped with Hydroquinone (HQ):

A polyaniline coating was deposited by spin coating a solution (0.6 g of polyaniline (emeraldine base, 50,000 mol wt) in 20 ml of 88% formic acid) on an ITO coated glass substrate. The coating is dried in an air circulated oven at 80 C. The color of the coating as deposited is deep green and after the drying process it is deep blue. The coating thickness was about 300 nm. Doping with hydroquinone was achieved by soaking the polyaniline coating in a solution of 0.25M hydroquinone in 80vol% propylene carbonate and 20vol % ionic liquid at 80° C. for 5 minutes and then washed with ethanol. After doping, the polyaniline changed from deep blue to pale yellow. The coating had an active cyclic voltametry (CV) response and could be colored and bleached. CV was conducted in 0.1M lithium triflate solution in acetonitrile while using a stainless steel counter electrode and silver as pseudo-reference electrode. At a scan rate of 20 mV/s, the electrode was colored at −0.56V versus silver wire and the optical modulation was recorded as shown below.

Modulation Range of Hydroquinone Doped Polyaniline

| Polyaniline Doped with | | | |
|---|---|---|---|
| Hydroquinone | 405 nm | 650 nm | 780 nm |
| | % Transmission | | |
| Reduced | 54 | 66 | 63 |
| Oxidized | 3 | 7 | 1 |

The modulation of hydroquinone doped polyaniline was surprisingly high at 405 nm. Thus this was deemed as a suitable material at all the three wavelengths of interest. Further, this material had good thermal stability in both (colored and bleached states) as shown in the next table where the transmission change was recorded for both states by subjecting them to an air circulated oven at 80 C No change in colored state at 650 and 405 nm was observed for a period of two hours. In the bleached state the transmission at 650 nm decreased from about 66 to about 40% and at 405 nm this changed from 54 to 50%. It appeared that the change at the end of two hours was leveling off Derivatives of hydroquinone and their mixtures with hydroquinone were also found suitable to give large range at both 405 and 650 nm. For example in a separate experiment the following results were obtained.

| | 405 nm | | | 650 nm | | |
|---|---|---|---|---|---|---|
| | (% T) | | | (% T) | | |
| | Re- | Oxi- | Δ(405 | Re- | Oxi- | Δ(650 |
| Dopant | duced | dized | nm) | duced | dized | nm) |
| Hydroquinone | 42 | 7 | 35 | 57 | 15 | 42 |
| Trimethylhydroquinone | 49 | 27 | 22 | 65 | 58 | 7 |
| Hydroquinone/ | 45 | 14 | 31 | 62 | 51 | 11 |
| Trimethylhydroquinone | | | | | | |

### Example 17

### Solid EC Cell with Polyaniline Doped with HQ and with UV Curable Electrolyte Layer

A doped HQ containing polyaniline was prepared as in Example 16 on an ITO coated glass substrate and then incorporated in the device. Polyaniline was bleached when incorporated in the device. ITO conductivity was about 15 ohms/square. The substrate size was about 2 cm×2 cm and the area coated with polyaniline was about 0.75 sq cm. A layer of UV curable electrolyte with the following composition was coated on top of doped polyaniline:
7.5 g Poly(propylene glycol) diacrylate (mol. wt. 475)
2.5 g Poly(propylene glycol) acrylate (mol. wt. 540)
0.5 g Pentacrylate (SR399LV from Sartomer, Exton, Pa.)
0.5 g Amine(CN371 from Sartomer, Exton, Pa.)
0.46 g Irgacure 500 (from Ciba Specialty Chemicals, White Plains, N.Y.)
2.4 ml Propylene carbonate
1.0 ml 1-Butyl-1-methylpyrrolyidium 1,1,1-trifluoro-N-[(trifluoromethyl)sulfonyl]-methanesulfonamide
0.1 g Lithium trifluoromethanesulfonate (0.05M)

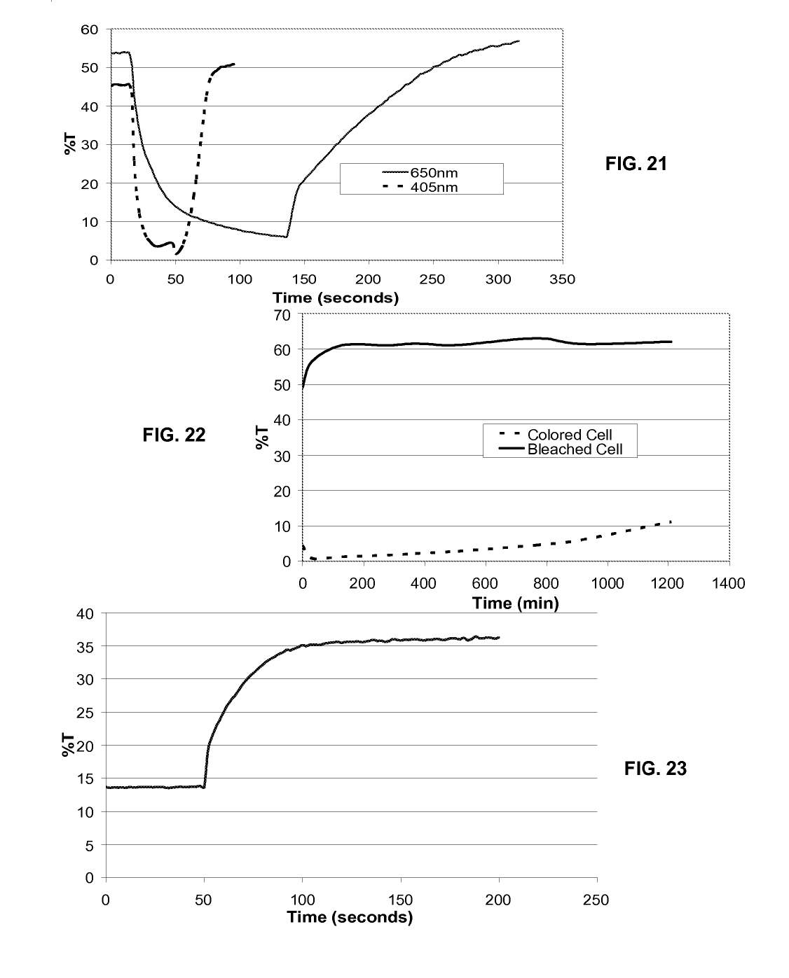

After coating with electrolyte another ITO coated glass of similar size, with a slight offset was lowered on top of the electrolyte with ITO touching this layer. The sandwich was then subjected to UV radiation for cure. The thickness of the electrolyte layer was about 1.5 microns. When a voltage of 2.75V was applied with polyaniline electrode being positive, the cell colored. The cell bleached when a reverse potential of 2.75V was applied. This is shown in FIG. 20 at 405 and 650 nm. The cell potential in colored and bleached state was 0 Volts. The cell was stored in colored state and a similar cell was stored in the bleached state at 80 C. Both of these were shorted when stored in either of the states. Their stability was high as seen from the change in transmission with time in FIG. 21.

### Example 18

### Additives to PANI to Improve its Adhesion to Other Coatings

For devices to work properly it is important that all layers must have good interface adhesion for proper transport of ions and electrons. We found that to improve the adhesion of polyanilne with other layers, particularly ion conducting layers deposited over it, that it is preferable to modify the polyaniline coating solution by adding ion-conducting material to it. For example addition of polymers with acid containing moieties, such as polyacrylic acid (PAA), Nafion® (Dupont, Wilmington, Del.), or polystyrene sulfonic acid was useful. The ion-conducting material coatings on top of modified polyaniline showed superior wetting during the coating operation. Further, the polymer added to polyaniline may be the same as the ion conducting layer or be a different one. The concentration of modifying polymer was preferably 50% of polyaniline by weight. A more preferred concentration was 10% or less.

### Example 19

### Devices with Polyaniline and Thiophene as Reductant

To make irreversible devices with no potential in the colored and the bleached states it was decided to couple non-reversible chemical reactions which were induced electrochemically. In these devices the expected reaction upon the application of bleach potential was electrochemical bleaching of the EC layer while a non-reversible polymerization was initiated of the thiophene. The devices were constructed with polyaniline (with 10% polyacrylic acid (molecular weight 2000) by weight ). The coatings were deposited on ITO coated glass by spin coating from 88% formic acid solutions. The thiophene was dissolved in a polyelectrolyte (PSS (polystyrene sulfonic acid), Nafion™ or PSSNa (polystyrene sulfonic acid; sodium salt)). The nafion solution was prepared in lower alcohols, the PSS and PSSNa solutions were prepared in water:ethanol 50:50. This was coated on a second ITO coated substrate, and these were assembled into a device by bringing the two coated substrates together and sandwiching an electrolyte. Initial experiments were carried out using liquid electrolytes which comprised of 0.1 molar lithium triflate in propylene carbonate. FIG. 22 shows that a cell made in this fashion with thiophene acetic acid had stable colored and bleached state when shorted. A similar cell was made where polyaniline was substituted with poly(2-methoxyanilne) and thiophene acetic acid was substituted with 2-nitrothiophene. This cell also showed good stability in both states.

### Example 20

### Devices with Polyaniline and Metal Salts as Reducing Agents

Devices are constructed with polyaniline coatings with similar compositions and process as in Example 18. The reductants are metal salts which are dissolved in a polyelectrolyte (PSS (polystyrene sulfonic acid), Nafion™ or PSSNa (polystyrene sulfonic acid; sodium salt)) in an aqueous solution comprising ethanol and water and coated on top of the polyaniline layer. To make a coating solution, Ig of vanadyl sulfate was added to 2 g of polyacrylic acid and 8 ml of water. Then 0.1 ml of this was added to 0.5 ml ethanol and 0.5 ml of polystyrenesulfonic acid (18 wt % in water) to make the coating solution. The device was constructed where polyaniline was 300 nm thick, electrolyte was 2.9 microns thick and the top electrode was gold in a thickness of 60 nm. The device had an initial reflection of 8% which changed to about 27% when a potential of 2.8V (polyaniline being negative) was applied. This device exhibited stable states when shorted in bleached and color mode. The device had no measurable potential across the terminals in either of the optical states. Another device was constructed where cobalt chloride was used instead of vanadyl sulfate. This also showed stable optical characteristics in both states and the device changed from about 7% reflectivity to 18% reflectivity when bleached at 2.8V.

### Example 21

### Playability of Disks Coated with Polyaniline

Several polyaniline coatings were deposited in the pattern and position as shown in FIG. 19 on the read side of as many DVD9s by spray coating through a stencil. The transmittance of these coatings when deposited on glass was 14, 35, 57, and 62 and 79% at 650 nm. These were evaluated for playability for on a personal DVD player (Emprex Model PD 7001, Emprex Technologies, Fremont, Calif.). The disks with coatings having a transmission of 14 and 35% did not play, whereas the others did.

### Example 22

### Playability of Disks Coated with Open and Closed EC Shutters

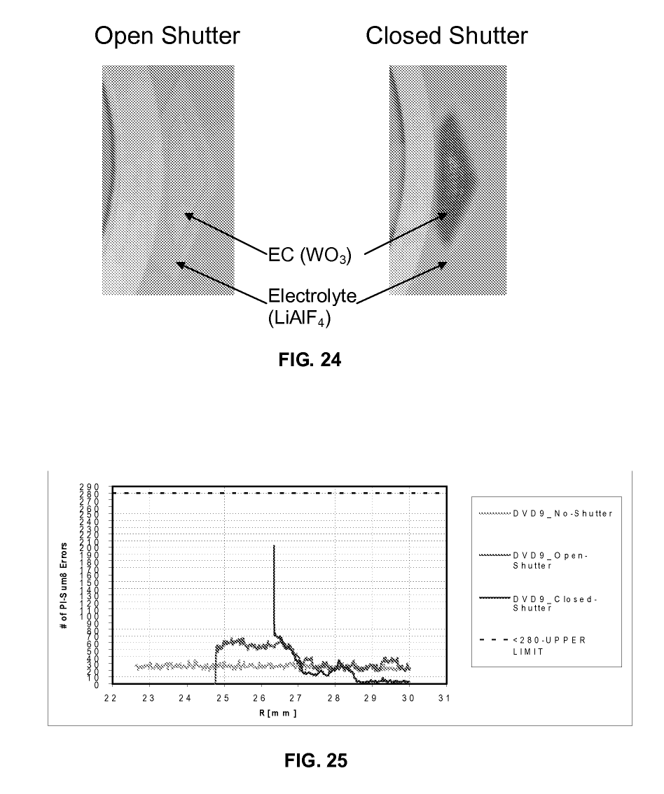

Two DVD-9 were coated with passive truncated diamond-shaped shutters, one in the open state and one in the closed state. The device stacks consisted of physical vapor deposited layers of ITO/WO₃(Li)/Li/AlF₄/ITO as shown by the photograph in FIG. 19. The radial extend of the truncated diamond covered a radius from approximately 22.6 mm through approximately 28.5 mm, with a maximum tangential extend of about 12 mm. In the closed shutter shown in FIG. 23, the WO₃ was lithiated with sufficient charge to bleach the shutter for open state simulation. FIG. 24 shows the digital error rate (measured as errors per 8 error correction code (ECC) blocks of the channel code for a DVD) for Layer 1 for the closed shutter and the open shutter measure by a DVD CATS Tester manufactured by Audio Development (Malmo, Sweden). As a reference the error rate from a disc from the same batch as the open shutter is also shown. Even though, for this particular open shutter there exist some elevated errors in the focus and track servo signals, the resultant increase in digital error is still small and well within the specification limits for DVD of a maximum 280 errors per 8 ECC blocks. The error rate for the closed shutter, however, sharply increases as the disc is played back from the outer diameter towards the inner diameter on the Layer 1 information layer of the opposite track path disc. Playback was ceased at approximately a radius of 26.2 mm before reaching the maximum tangential extent of the closed shutter.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed is:

1. An electrochromic device having a first optical state and a second optical state, comprising:
an electrolyte layer and an electrochromic layer having almost no potential between the layers when the electrochromic layer is in the first optical state; and
the electrolyte layer and the electrochromic layer having almost no potential between the layers when the electrochromic layer is in the second optical state.

2. The electrochromic device according to claim 1, where there is less than about 0.3 volts potential between the layers when the electrochromic layer is in its first optical state.

3. The electrochromic device according to claim 1, where there is less than about 0.3 volts potential between the layers when the electrochromic layer is in its second optical state.

4. The electrochromic device according to claim 1, where there is about 0 volts potential between the layers when the electrochromic layer is in its first optical state.

5. The electrochromic device according to claim 1, where there is about 0 volts potential between the layers when the electrochromic layer is in its second optical state.

6. The electrochromic device according to claim 1, where:
the electrochromic layer is capable of being reduced, and changes from the first optical state to the second optical state upon reduction; and
the electrolyte layer comprises a material that is capable of being oxidized upon the application of a voltage to the device.

7. The electrochromic device according to claim 1, where:
the electrochromic layer is capable of being oxidized, and changes from the first optical state to the second optical state upon oxidation; and
the electrolyte layer comprises a material that is capable of being reduced upon the application of a voltage to the device.

8. The electrochromic device according to claim 1, where the electrolyte layer comprises organic material.

9. The electrochromic device according to claim 1, where the electrolyte layer comprises polymeric material.

10. The electrochromic device according to claim 1, where the electrolyte layer comprises a polymeric salt.

11. The electrochromic device according to claim 10, where the electrolyte layer comprises a redox material.

12. The electrochromic device according to claim 10, where the electrolyte layer comprises at least one of thiophene, furan, vanadyl sulfate or cobalt chloride.

13. The electrochromic device according to claim 1, where the electrolyte layer comprises a redox material.

14. The electrochromic device according to claim 1, where the electrolyte layer comprises at least one of thiophene, furan, vanadyl sulfate or cobalt chloride.

15. The electrochromic device according to claim 1, where the electrochromic layer comprises organic material.

16. The electrochromic device according to claim 1, where the electrochromic layer comprises polyaniline.

17. The electrochromic device according to claim 1, where the electrochromic layer comprises an acid.

18. The electrochromic device according to claim 1, where the electrochromic layer comprises a polyacrylic acid.

19. The electrochromic device according to claim 1, where the electrolyte layer comprises an acid.

20. The electrochromic device according to claim 1, where the electrolyte layer comprises polymeric acid.

21. The electrochromic device according to claim 1, where the electrolyte layer and the electrochromic layer each comprise the same acid.

22. The electrochromic device according to claim 1, where the electrolyte layer and the electrochromic layer each comprise polyacrylic acid.

23. The electrochromic device according to claim 1, where the electrochromic layer comprises hydroquinone.

24. The electrochromic device according to claim 1, where the electrolyte layer is between the electrochromic layer and a counter electrode layer.

25. The electrochromic device according to claim 24, where the electrolyte layer comprises inorganic material.

26. The electrochromic device according to claim 24, where the electrolyte layer comprises LiAlF or LiPON.

27. The electrochromic device according to claim 24, where the electrochromic layer comprises Li WO₃.

28. The electrochromic device according to claim 1 or 24, where the electrochromic layer comprises metal.

29. The electrochromic device according to claim 1 or 24, where the electrochromic layer comprises magnesium, aluminum, nickel, tungsten, tin, molybdenum, manganese, zinc, cobalt, chromium, or cobalt.

30. The electrochromic device according to claim 1 or 24, where in the first optical state the electrochromic layer comprises a metal.

31. The electrochromic device according to claim 1 or 24, where in the second optical state the electrochromic layer comprises an oxidized metal compound.

32. The electrochromic device according to claim 24, wherein the counter electrode layer comprises NiO, Ir₂O₃, CoO, or V₂O₅.

33. The electrochromic device according to claim 1, wherein the electrochromic device is arranged on an optical disk.

34. The electrochromic device according to claim 1, wherein the electrochromic layer and the electrolyte layer connect to respective electrodes for receiving a power signal.

35. An electrochromic device having a first optical state and a second optical state, comprising:
an electrochromic layer;
an electrolyte layer adjacent the electrochromic layer;
a material positioned to react with the electrochromic layer; and
wherein the material is in a first stable state when the device is in the first optical state and the material is in a second stable state when the device is in the second optical state.

36. The electrochromic device according to claim 35, wherein the material is in the electrolyte layer.

37. The electrochromic device according to claim 35, wherein the material is in the electrochromic layer.

38. The electrochromic device according to claim 35, wherein the first stable state is a first stable oxidation state.

39. The electrochromic device according to claim 35, wherein the second stable state is a second stable oxidation state.

40. The electrochromic device according to claim 35, wherein:
the material in the first stable state is VO⁺²; and
the material in the second stable state is VO₂.

41. The electrochromic device according to claim 35, where the electrolyte layer is between the electrochromic layer and a counter electrode layer.

42. The electrochromic device according to claim 41, wherein the material is in the counter electrode layer.

43. The electrochromic device according to claim 35, further comprising a first electrode connected to the electrochromic layer and a second electrode coupled to the electrolyte layer.

44. The electrochromic device according to claim 43, wherein the device is arranged so that the layers are in the order of 1) the first electrode; 2) the electrochromic layer; 3) the electrolyte layer; and 4) the second electrode.

45. The electrochromic device according to claim 35, further comprising:
the electrochromic layer in the first optical state when a conductive shorting line shorts the device; and
wherein the electrochromic layer takes more than about 8 hours at room temperature to transition from the first optical state to the second optical state.

46. The electrochromic device according to claim 35, further comprising:
the electrochromic layer in the first optical state when a conductive shorting line shorts the device; and
wherein the electrochromic layer takes more than about 4 hours at about 50 degrees Celsius or greater to transition from the first optical state to the second optical state.

47. The electrochromic device according to claim 35, further comprising:
the electrochromic layer in the first optical state when a shorting line shorts the device; and
wherein the electrochromic layer takes more than about 1 hour at about 80 degrees Celsius or greater to transition from the first optical state to the second optical state.

48. The electrochromic device according to claim 35, wherein the first stable state is a substantially transparent optical state.

49. The electrochromic device according to claim 35, wherein the first stable state is a substantially opaque optical state.

50. The electrochromic device according to claim 35, wherein the second stable state is a substantially transparent optical state.

51. The electrochromic device according to claim 35, wherein the second stable state is a substantially opaque optical state.

52. The electrochromic device according to claim 35, wherein:
the material in the first stable state is a monomer; and
the material in the second stable state is polymerized monomer.

53. A method of making an electrochromic device, comprising:
depositing an electrolyte layer on a substrate;
depositing an electrochromic layer adjacent the electrolyte layer;
providing a pair of electrodes, one electrode connected to the electrolyte layer and the other electrode connected to the electrochromic layer; and
wherein the electrolyte layer and electrochromic layer have less than 0.3V potential between them when the electrochromic layer is fully bleached or fully colored.

54. The method according to claim 53, wherein the step of depositing the electrochromic layer comprises depositing PANI.

55. The method according to claim 54, wherein the step of providing the pair of electrodes comprises depositing at least one of the electrodes using a transparent conducting material.

56. A method of making an electrochromic device, comprising:
depositing an electrolyte layer;
depositing an electrochromic layer adjacent the electrolyte layer;
providing a pair of electrodes, one electrode connected to the electrolyte layer and the other electrode connected to the electrochromic layer; and
wherein the electrolyte layer and electrochromic layer have less than 0.3V potential between them when the electrochromic layer is fully bleached or fully colored.

57. The method according to claim 56, further including the step of adjusting the pH of the electrolyte layer to change the reversibility, optical; or kinetic characteristics of the device.

58. The method according to claim 56, further including the step of adding PSS acid to the electrolyte layer to change the reversibility, optical or kinetic characteristics of the device.

59. The method according to claim 56, further including the step of adjusting the pH of the electrochromic layer to change the reversibility, optical or kinetic characteristics of the device.

60. The method according to claim 56, further including the step of adding polyacrlyic acid to the electrochromic layer to change the reversibility, optical or kinetic characteristics of the device.

61. The method according to claim 56, further comprising the step of depositing a counter electrode layer adjacent the electrolyte layer.

62. The method according to claim 56 or 61, further including the step of doping the electrochromic layer to change the reversibility, optical or kinetic characteristics of the device.

63. The method according to claim 56 or 61, further including the step of doping the electrolyte layer to change the reversibility, optical or kinetic characteristics of the device.

64. The method according to claim 61, further including the step of doping the counter electrode layer to change the reversibility, optical or kinetic characteristics of the device.

65. The method according to claim 56, further including the step of adding a common material to both the electrochromic layer and the electrolyte layer to facilitate improved adhesion between the electrochromic layer and the electrolyte layer.

66. The method according to claim 56, further including the step of adding about 10% of a common material to both the electrochromic layer and the electrolyte layer to facilitate improved adhesion between the electrochromic layer and the electrolyte layer.

67. The method according to claim 56, further including the step of adding a polyacrylic acid to both the electrochromic layer and the electrolyte layer to facilitate improved adhesion between the electrochromic layer and the electrolyte layer.

68. The method according to claim 56, further including the step of adding a material to the electrochromic layer to improve transmission characteristics at a target frequency.

69. The method according to claim 68, wherein the material is hydroquinone.

70. The method according to claim 68, wherein the target frequency is 405 nm.

71. The method according to claim 68, wherein the electrochromic layer comprises PANI, the material is hydroquinone, and the target frequency is 405 nm.
